(19) United States
(12) Patent Application Publication
(10) Pub. No.: US 2025/0299072 A1
(43) Pub. Date: Sep. 25, 2025

(54) DATA PROCESSING METHOD AND APPARATUS, DEVICE, AND READABLE STORAGE MEDIUM

(71) Applicant: TENCENT TECHNOLOGY (SHENZHEN) COMPANY LIMITED, Shenzhen, Guangdong (CN)

(72) Inventor: Ye LIU, Shenzhen (CN)

(73) Assignee: TENCENT TECHNOLOGY (SHENZHEN) COMPANY LIMITED, Shenzhen (CN)

(21) Appl. No.: 19/233,363

(22) Filed: Jun. 10, 2025

Related U.S. Application Data
(63) Continuation of application No. PCT/CN2024/083332, filed on Mar. 22, 2024.

(30) Foreign Application Priority Data
May 19, 2023 (CN) 202310572043.6

(51) Int. Cl. G06N 5/025

(52) U.S. Cl. CPC G06N 5/025

(57) ABSTRACT

A data processing method, apparatus, and computer-readable storage medium for processing single-modality and cross-modality data. The method includes acquiring a training task group set and determining a modality type for each group as single-modality or cross-modality. Attention interaction is performed on each training task group to obtain an attention representation vector, and a target routing layer is determined based on the modality type. Feature prediction is performed on the attention representation vector using the target routing layer to obtain a predicted modality representation vector. The method optimizes both single-modality and cross-modality routing layers based on the predicted representation vectors and corresponding modality types, enabling specialized processing for each modality type through the respective optimized routing layers.

### CROSS-REFERENCE TO RELATED APPLICATIONS

The disclosure is a continuation application of International Application No. PCT/CN2024/083332 filed on Mar. 22, 2024 which claims priority to Chinese Patent Application No. 202310572043.6, filed with the China National Intellectual Property Administration on May 19, 2023, the disclosures of each being incorporated by reference herein in their entireties.

### FIELD

The disclosure relates to the field of computer technologies, a data processing method and apparatus, a device, and a readable storage medium.

### BACKGROUND

With the rapid development of multimedia technologies, media data (such as pictures, texts, videos, and audios) is massively produced. With the generation of massive media data, an understanding task (such as a video understanding task) of the media data becomes particularly important. The understanding task of the media data can provide a large number of abundant and diverse media tags (such as a dance tag, a singing tag, a competition tag, and a game tag) for the media data. Various media processing may be conveniently performed on the media data by using the media tags of the media data. For example, processing such as media retrieval, classification, filing, media recommendation, and secondary media editing may be conveniently performed on the media data.

In a media retrieval task, related media segments, text tags, title information, and the like of the media data may be conveniently retrieved by using the media tags. Media retrieval is of great significance for media recommendation and media processing. However, with an increasingly large requirement on media retrieval, there is also an increasingly high requirement on a media retrieval capability. For example, after a piece of media data whose modality type is a text type is inputted, a requirement on a retrieval result is not limited to the media data whose modality type is the text type, and media data whose modality type is a non-text type (such as a video type, an audio type, or an image type) also may be retrieved. That is, in a media data retrieval service, a multi-modality-based retrieval performance requirement is increasing.

However, in the related art, media data multi-modality understanding tasks may be understood and inferred by a unified model. For each modality, a feature of the modality may be extracted, and then multi-modality information of features of all modalities is fused, to finally obtain multi-modality information. However, in a related technology, when a model is trained, to improve accuracy of multi-modality information, single-modality personality information may be eliminated, and information between different modalities is extracted. As a result, accuracy of understanding of single-modality data by the model may be seriously affected, thereby seriously affecting accuracy of a processing result of the single-modality data in a subsequent task (such as a retrieval task).

### SUMMARY

Provided are a data processing method and apparatus, a device, a storage medium, and a program product, which can implement efficient processing of single-modality and cross-modality data through adaptive routing layers and attention interaction techniques.

According to some embodiments, a data processing method, performed by a computer device, includes: acquiring a training task group set comprising a plurality of training task groups, each denoted as Si, i being a positive integer; determining, for each training task group Si, a modality type as a single-modality type or a cross-modality type, wherein a training task group of the single-modality type comprises a single piece of sample media data, and a training task group of the cross-modality type comprises at least two pieces of sample media data of different modality types; performing attention interaction on the training task group Si based on a modality representation model to obtain an attention representation vector, wherein the attention interaction is configured to allow elements in the training task group Si to interact; determining, based on the modality type, a target routing layer from a single-modality routing layer and a cross-modality routing layer in the modality representation model; performing feature prediction on the attention representation vector based on the target routing layer to obtain a predicted modality representation vector; and optimizing the single-modality routing layer based on the predicted modality representation vector and the modality type being the single-modality type; and optimizing the cross-modality routing layer based on the predicted modality representation vector and the modality type being the cross-modality type; wherein the optimized single-modality routing layer is configured to perform feature prediction on a task group of the single-modality type, and an optimized cross-modality routing layer is configured to perform feature prediction on a task group of the cross-modality type.

According to some embodiments, a data processing apparatus, includes: at least one memory configured to store program code; and at least one processor configured to read the program code and operate as instructed by the program code, the program code including: acquiring code configured to cause at least one of the at least one processor to acquire a training task group set comprising a plurality of training task groups, each denoted as Si, i being a positive integer; determining code configured to cause at least one of the at least one processor to determine, for each training task group Si, a modality type as a single-modality type or a cross-modality type, wherein a training task group of the single-modality type comprises a single piece of sample media data, and a training task group of the cross-modality type comprises at least two pieces of sample media data of different modality types; attention code configured to cause at least one of the at least one processor to perform attention interaction on the training task group Si based on a modality representation model to obtain an attention representation vector, wherein the attention interaction is configured to allow elements in the training task group Si to interact; routing code configured to cause at least one of the at least one processor to determine, based on the modality type, a target routing layer from a single-modality routing layer and a cross-modality routing layer in the modality representation model; prediction code configured to cause at least one of the at least one processor to perform feature prediction on the attention representation vector based on the target routing layer to obtain a predicted modality representation vector; and optimization code configured to cause at least one of the at least one processor to: optimize the single-modality routing layer based on the predicted modality representation vector and the modality type being the single-modality type; and optimize the cross-modality routing layer based on the predicted modality representation vector and the modality type being the cross-modality type; wherein the optimized single-modality routing layer is configured to perform feature prediction on a task group of the single-modality type, and an optimized cross-modality routing layer is configured to perform feature prediction on a task group of the cross-modality type.

According to some embodiments, a non-transitory computer-readable storage medium, storing computer code which, when executed by at least one processor, causes the at least one processor to at least: acquire a training task group set comprising a plurality of training task groups, each denoted as Si, i being a positive integer; determine, for each training task group Si, a modality type as a single-modality type or a cross-modality type, wherein a training task group of the single-modality type comprises a single piece of sample media data, and a training task group of the cross-modality type comprises at least two pieces of sample media data of different modality types; perform attention interaction on the training task group Si based on a modality representation model to obtain an attention representation vector, wherein the attention interaction is configured to allow elements in the training task group Si to interact; determine, based on the modality type, a target routing layer from a single-modality routing layer and a cross-modality routing layer in the modality representation model; perform feature prediction on the attention representation vector based on the target routing layer to obtain a predicted modality representation vector; and optimize the single-modality routing layer based on the predicted modality representation vector and the modality type being the single-modality type; and optimize the cross-modality routing layer based on the predicted modality representation vector and the modality type being the cross-modality type; wherein the optimized single-modality routing layer is configured to perform feature prediction on a task group of the single-modality type, and an optimized cross-modality routing layer is configured to perform feature prediction on a task group of the cross-modality type.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of a network architecture of a data processing system according to some embodiments.

FIG. 2 is a schematic flowchart of a data processing method according to some embodiments.

FIG. 3 is a schematic architectural diagram of a transformer architecture according to some embodiments.

FIG. 4 is a schematic diagram of a modality routing distribution architecture according to some embodiments.

FIG. 5 is a schematic diagram of a scenario of media data retrieval according to some embodiments.

FIG. 6 is a schematic flowchart of optimizing a single-modality routing layer according to some embodiments.

FIG. 7 is a schematic flowchart of optimizing a cross-modality routing layer according to some embodiments.

FIG. 8 is a schematic structural diagram of a data processing apparatus according to some embodiments.

FIG. 9 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The disclosure relates to artificial intelligence (AI) and related concepts. For ease of understanding, the following briefly describes the AI and the related concepts.

AI is a theory, a method, a technology, and an application system that use a digital computer or a machine controlled by the digital computer to simulate, extend, and expand human intelligence, perceive an environment, acquire knowledge, and use the knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a nature language processing (NLP) technology, and machine learning (ML)/deep learning.

With the research and progress of the AI technology, it has been researched and applied in multiple fields, such as smart homes, smart wearable devices, virtual assistants, smart speakers, intelligent marketing, unmanned driving, autonomous driving, drones, robots, smart healthcare, and intelligent customer service. With the development of the technology, the AI technology will be applied to more fields, and plays an increasingly important role.

Solutions provided in some embodiments belong to ML and NLP technologies subordinate to the field of AI.

ML is a multi-field interdiscipline, and relates to a plurality of disciplines such as a probability theory, statistics, an approximation theory, convex analysis, and an algorithm complexity theory. ML specializes in studying how a computer simulates or implements a human learning behavior to acquire new knowledge or skills, and reorganize an existing knowledge structure, so as to keep improving its performance. ML is the core of AI, is a way to make the computer intelligent, and is applied to various fields of AI. ML and deep learning generally include technologies such as an artificial neural network, a belief network, reinforcement learning, transfer learning, inductive learning, and learning from demonstrations.

NLP is an important direction in the field of computer science and AI NLP studies various theories and methods that can realize efficient communication between humans and computers by using a natural language. NLP is a science that integrates linguistics, computer science, and mathematics. Therefore, study in this field involves a natural language, for example, a language that people use every day, and NLP is closely related to the study of linguistics. The NLP technology generally includes technologies, such as text processing, semantic understanding, machine translation, robot question answering, and knowledge mapping.

In some embodiments, semantic analysis processing may be performed on text data (such as title data and description data) related to media data (such as text data and video data) by using the NLP technology, to obtain a semantic analysis result of the media data, so as to better understand the media data. In addition, in some embodiments, related models (e.g., a modality representation model mentioned subsequently) may be trained and optimized by using the ML technology, to improve accuracy of an output result of the model.

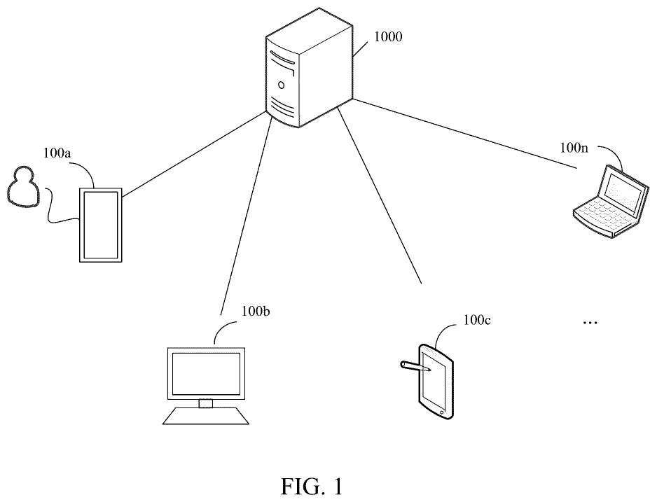

For ease of understanding, referring to FIG. 1, FIG. 1 is a diagram of a network architecture of a data processing system according to some embodiments. As shown in FIG. 1, the network architecture may include a service server 1000 and a terminal device cluster. The terminal device cluster may include one terminal device or a plurality of terminal devices. A quantity of the terminal device(s) is not limited herein. As shown in FIG. 1, the plurality of terminal devices may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n may establish a network connection with the service server 1000 respectively, so that each terminal device can perform data interaction with the service server 1000 by using the network connection. In addition, any terminal device in the terminal device cluster 100 may be an intelligent device on which an operating system runs. The operating system of the terminal device is not limited in some embodiments.

The terminal device in the data processing system as shown in FIG. 1 may be a smartphone, a tablet computer, a laptop computer, a desktop computer, a mobile internet device (MID), a point of sales (POS) machine, a smart speaker, a smart television, a smart watch, a smart vehicle-mounted terminal, a virtual reality (VR) device, an augmented reality (AR) device, or the like, but is not limited thereto. The terminal device is generally equipped with a display apparatus. The display apparatus may be a display, a display screen, a touchscreen, or the like. The touchscreen may be a touch-sensitive display, a touch panel, or the like.

The service server in the data processing system as shown in FIG. 1 may be an independent physical server, or may be a server cluster or a distributed system including a plurality of physical servers, or may be a cloud server providing cloud computing services, such as a cloud service, a cloud database, cloud computing, a cloud function, cloud storage, a network service, cloud communication, a middleware service, a domain name service, a security service, a content delivery network (CDN), big data, and an AI platform. The terminal device and the service server may be connected directly or indirectly in a wired communication manner or a wireless communication manner, which is not limited in the disclosure.

In a possible implementation, applications such as a video application, a browser application, a game application, and an education application run on the terminal device (e.g., the terminal device 100a). The applications are not described one by one by way of example herein. In some embodiments, the video application is used as an example for description. An object may run the video application on a terminal device, and the video application may provide media data (such as text data, video data, audio data, and image data) for the object in a form of a feeds stream (feed may refer to a source of news, and feed may also be translated as raw feed, data feed, news feed, content feed, digest feed, source feed, or news subscription. It is a data format, through which the application propagates latest information to the object, generally arranged in a timeline manner). The object may browse the media data in the video application. The video application may also provide a retrieval function for the object, and the object may retrieve, by entering a piece of information, media data (such as text data, image data, audio data, and video data) associated with the entered information. For example, after the object enters a piece of text data, the video application may output another piece of text data associated with the text data, or may output image data, video data, audio data, and the like associated with the text data. Alternatively, after the object enters a piece of image data, the video application may output another piece of image data associated with the image data, or may output video data, text data, audio data, and the like associated with the image data. The image data, the text data, the audio data, and the video data may be considered as media data of different modality types. For example, the image data may be understood as media data whose modality type is an image modality type, and the video data may be understood as media data whose modality type is a video modality type. That is, the video application may provide a retrieval function of media data of a multi-modality type. To improve accuracy of a multi-modality retrieval result, the disclosure provides a multi-modality joint training framework based on a modality routing distribution mechanism. Based on training of only one modality representation model, a task of determining cross-modality (cross-modality refers to a modality combination of two or more modalities) and single-modality modality representation features is completed. Based on modality representation features of various modalities (which may include the cross-modality modality representation feature and the single-modality modality representation feature), media data of different modality types may be retrieved. Therefore, problems such as large storage, time consumption of retrieval, and repeated calculation of the model can be alleviated. As a result, single-modality and cross-modality tasks can promote each other and respectively maintain good performance, thereby improving universality and accuracy.

The modality representation model may be deployed in the service server 1000. The service server 1000 may collect information (e.g., entered text data) entered by the object in the video application. Based on the information entered by the object in the video application, the service server 1000 may perform inference analysis on the information entered by the object by using the modality representation model, to obtain a modality representation vector of the entered information. Based on the modality representation vector of the entered information, the service server 1000 may determine media data (such as text data, image data, video data, and audio data) associated with the entered information. The modality representation model deployed in the service server 1000 may include different modality routing layers, which, for example, may include a text modality routing layer configured to route the text data, an image modality routing layer configured to route the image data, an audio modality routing layer configured to route the audio data, and may further include a cross-modality routing layer configured to route multi-modality media data. Therefore, for entered information of different modality types, corresponding routing processing may be performed by corresponding modality routing layers (the routing layer herein may refer to a fully connected layer, and the routing processing may refer to performing linear transformation processing by using the fully connected layer; since the performing linear transformation processing by using the fully connected layer actually refers to performing feature integration prediction processing by using the fully connected layer, the routing processing herein may also be understood as performing feature prediction processing), to obtain a modality representation vector of the entered information. For example, when the entered information is text data, the text modality routing layer may perform routing processing on the text data. When the entered information is image data, the image modality routing layer may perform routing processing on the image data.

That is, in the disclosure, a routing distribution mechanism is configured in the modality representation model, different modality routing layers are configured for different modality types, and entered information of different modality types may be distributed to corresponding modality routing layers for routing processing. Compared with the technology in which a unified routing layer performs unified processing on input data of different modality types, the manner of configuring the routing distribution mechanism may make a routing layer more targeted. Input data of one modality type may be routed in a targeted manner by the corresponding modality routing layer, and input data of various modality types may be adapted to based on different modality routing layers. In this way, universality of the modality representation model for different modality types can be improved well. In addition, since input data of different modality types is processed by corresponding modality routing layers in a targeted manner, a processing process thereof conforms to characteristics of the modality types, and an obtained processing result (for example, a representation result of the input data) may also be more accurate. That is, accuracy of representation results of data of different modality types can be improved.

In the disclosure, to improve accuracy of an output result of the modality representation model, the modality representation model may be trained and optimized. During the training of the modality representation model, since different modality routing layers are configured, the different modality routing layers may be trained in a targeted manner by using training samples of different modality types. For example, the text-modality routing layer may be trained by using text sample data, the image-modality routing layer may be trained by using image sample data, and the cross-modality routing layer may be trained by using cross-modality sample data (e.g., sample data including both image sample data and text sample data). A routing layer for only one modality type, such as the text modality routing layer or the image modality routing layer, may be referred to as a single-modality routing layer in the disclosure. A routing layer for a plurality of modality types may be referred to as a cross-modality routing layer in the disclosure. The cross-modality routing layer may process data of a multi-modality type. The single-modality routing layer may be trained by using training data (a training task group) whose modality type is a single-modality type (such as a text modality type, an image modality type, or an audio modality type). The cross-modality routing layer may be trained by using training data (a training task group) whose modality type is a cross-modality type.

In the disclosure, a training task group set may be configured. For example, a piece of sample media data and a modality type corresponding thereto may be combined into a training task group. Alternatively, two pieces of sample media data of different modality types and modality types corresponding thereto may be combined into a training task group. Based on this, a training task group set including the single-modality type and the cross-modality type may be obtained by using a combination of the sample media data and the modality types. For example, when the sample media data is sample text data 1, a modality type thereof is the text modality type, and then a training task group <sample text data 1, text modality type> may be obtained after a combination thereof. The training task group includes only a piece of text data, and a modality type to which the training task group belongs is the text modality type (the single-modality type). In another example, when the sample media data is sample image data 1, a modality type thereof is an image modality type, and then a training task group <sample image data 1, image modality type> may be obtained after a combination thereof. The training task group includes only a piece of image data, and a modality type to which the training task group belongs is the image modality type (the single-modality type). In another example, when the sample media data is sample text data 1 and sample image data 1, a modality type thereof includes the text modality type and the image modality type, and then a training task group <sample text data 1-sample image data 1, text modality type-image modality type> may be obtained after a combination thereof. The training task group includes only a piece of text data and a piece of image data, and a modality type to which the training task group belongs is the cross-modality type. That is, the training task group in the disclosure may include a training task group of the single-modality type and a training task group of the cross-modality type. The training task group of the single-modality type may include only sample media data of one modality type, and the modality type may be the text modality type, the image modality type, the audio modality type, or the like. The training task group of the cross-modality type may include sample media data of two or more different modality types.

Further, the modality representation model may be invoked to perform attention interaction processing on each training task group. The attention interaction processing herein may refer to performing multi-head self-attention processing thereon based on a multi-head self-attention mechanism. Since each element in the input data can fully interact with other elements after the multi-head self-attention processing, in the disclosure, the multi-head self-attention processing is referred to as attention interaction processing, and a result obtained by using the attention interaction processing is referred to as an attention representation vector corresponding to the training task group. Subsequently, a target routing layer matching each attention representation vector may be determined in the single-modality routing layer and the cross-modality routing layer that are included in the modality representation model based on the modality type to which the training task group belongs. Routing processing (feature prediction processing) may be performed on the attention representation vector of the training task group by using the target routing layer. Finally, the modality representation vector corresponding to the training task group may be obtained (the modality representation vector corresponding to the training task group is a feature vector outputted by the target routing layer and configured for representing a modality type; since the modality representation model may be trained in a training phase, the modality representation vector outputted by the target routing layer may be understood as a predicted value, the outputted modality representation vector may be referred to as a predicted modality representation vector, and training optimization may be performed on the target routing layer based on the predicted modality representation vector, so that the modality representation vector outputted by the modality representation model is increasingly accurate). For example, assuming that a modality type to which a training task group belongs is the text modality type in the single-modality type, after the attention representation vector of the training task group is obtained, the text modality routing layer may be determined as a target routing layer of the training task group in the single-modality routing layer included in the modality representation model, a predicted modality representation vector corresponding to the training task group may be outputted based on the text modality routing layer, and the text modality routing layer may be correspondingly trained and optimized based on the predicted modality representation vector corresponding to the training task group.

That is, when the predicted modality representation vector corresponding to each training task group in the training task group set is determined, a corresponding single-modality routing layer (such as a text modality routing layer, an image modality routing layer, an audio modality routing layer, or a video modality routing layer) may be optimized based on the predicted modality representation vector corresponding to the training task group whose modality type is the single-modality type (such as a text modality type, an image modality type, an audio modality type, or a video modality type), and the optimized single-modality routing layer may perform routing processing on data of the single-modality type. Similarly, the cross-modality routing layer may be optimized based on the predicted modality representation vector corresponding to the training task group whose modality type is the cross-modality type, and the optimized cross-modality routing layer may perform routing processing on data of the cross-modality type.

Some embodiments provides a multi-modality joint training framework based on a modality routing distribution mechanism. Based on training of only one modality representation model, a task of outputting cross-modality and single-modality modality representation vectors may be completed. Based on modality representation vectors of various modalities, media data of different modality types may be retrieved. Therefore, problems such as large storage, time consumption of retrieval, and repeated calculation of the model can be alleviated. As a result, single-modality and cross-modality tasks can promote each other and respectively maintain good performance, thereby improving universality and accuracy.

The method described in some embodiments may be performed by a computer device. The computer device includes, but is not limited to, the terminal device or the service server mentioned in FIG. 1.

In some embodiments, related data such as user information and user data (e.g., information entered by the foregoing object) is obtained only after manual authorization of a user (for example, after the user agrees). That is, when the foregoing embodiments of the disclosure are applied to a product or technology, the method provided in some embodiments and related functions are operated with permission or consent of the user (the functions provided in some embodiments may be enabled by the user actively), and collection, use, and processing of the related data may obey related laws, regulations, and standards of related districts.

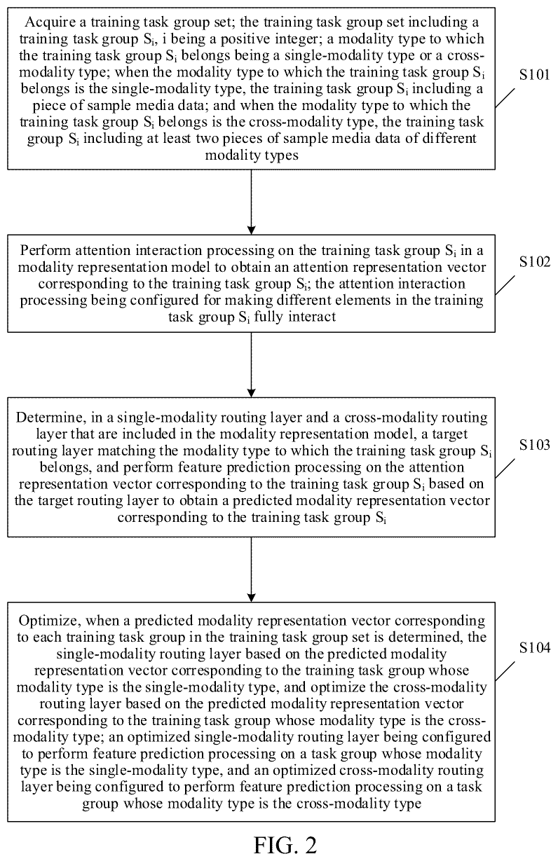

For ease of understanding, a data processing method provided in some embodiments is described below with reference to the accompanying drawings. Referring to FIG. 2, FIG. 2 is a schematic flowchart of a data processing method according to some embodiments. The method may be performed by a computer device. The computer device may be a terminal device (e.g., any terminal device in the terminal device cluster shown in FIG. 1, such as the terminal device 100a). The computer device may be a server (e.g., the service server 1000 in some embodiments corresponding to FIG. 1). The computer device may be a terminal device and a server. For ease of understanding, this embodiment is described with an example in which the method is performed by the terminal device. As shown in FIG. 2, the data processing method may include at least the following operation S101 to operation S104:

Operation S101: Acquire a training task group set; the training task group set including a training task group Sᵢ, i being a positive integer; a modality type to which the training task group Sᵢ belongs being a single-modality type or a cross-modality type; when the modality type to which the training task group Sᵢ belongs is the single-modality type, the training task group Sᵢ including a piece of sample media data; and when the modality type to which the training task group Sᵢ belongs is the cross-modality type, the training task group Sᵢ including at least two pieces of sample media data of different modality types.

In the disclosure, the single-modality type may refer to a modality type to which media data belongs, and may include a text modality type, an image modality type, an audio modality type, and a video modality type. A modality type to which a training task group belongs may be determined based on sample media data included in the training task group. For example, if the training task group includes only a piece of sample media data and a modality type to which the sample media data belongs is the text modality type (for example, the sample media data is sample text data), the modality type to which the training task group belongs may be the single-modality type and may be the text modality type. In another example, the training task group includes only a piece of sample media data and a modality type to which the sample media data belongs is the image modality type (for example, the sample media data is sample image data), a modality to which the training task group belongs may be the single-modality type and may be the image modality type. That is, when a training task group includes only sample media data of one modality type, a modality type to which the training task group belongs may be the single-modality type, and a modality type is determined based on the modality type of the included sample media data. Similarly, it may be deduced that, if a training task group includes two or more pieces of sample media data and modality types to which the sample media data belongs are different, it may be determined that the modality type to which the training task group belongs is the cross-modality type (or the multi-modality type). For example, if a training task group includes both sample text data (sample media data whose modality type is the text modality type) and sample video data (sample media data whose modality type is the video modality type), it may be determined that the modality type to which the training task group belongs is the cross-modality type.

That is, the sample media data in the disclosure may be media data used as a training sample, which may include sample text data, sample image data, sample audio data, or sample video data. When a training task group includes sample media data of one modality type, it may be determined that a modality type to which the training task group belongs is the single-modality type, and a modality type to which the sample media data belongs may be determined as the modality type to which the training task group belongs. However, when a training task group includes sample media data of a plurality of (two or more) modality types, it may be determined that a modality type to which the training task group belongs is the cross-modality type or the multi-modality type.

A implementation for acquiring a training task group set may be as follows: N (N is a positive integer) pieces of sample media data may be acquired; where a modality type to which one of the N pieces of media data belongs is either a first modality type or a second modality type; and the first modality type is different from the second modality type; and task group construction processing may be performed on the N pieces of sample media data based on the modality type to which each of the N pieces of sample media data belongs, thereby obtaining the training task group set.

The first modality type and the second modality type herein may refer to different modality types of the media data, both the first modality type and the second modality type may refer to the text modality type, the image modality type, the audio modality type, or the video modality type, and the first modality type is different from the second modality type. For example, when the first modality type is the text modality type, the second modality type may refer to any one or more of the image modality type, the audio modality type, and the video modality type, and when the first modality type is the image modality type, the second modality type may be any one or more of the text modality type, the audio modality type, and the video modality type. In the disclosure, a plurality of pieces of sample media data of different modality types used as samples are acquired in advance, and then task group construction processing is performed based on modality types of the sample media data, to obtain a training task group including different sample media data, thereby obtaining a training task group set.

A implementation for performing task group construction processing on the N pieces of sample media data based on the modality type to which each of the N pieces of sample media data belongs, to obtain the training task group set may be as follows: first sample media data of the N pieces of sample media data may be combined with a first identifier configured for representing the first modality type, thereby obtaining a first training task group whose modality type is the first modality type; where the first sample media data is any of the N pieces of sample media data whose modality type is the first modality type. The N pieces of sample media data include media data of the first modality type and media data of the second modality type. Any piece of media data whose modality type is the first modality type may be referred to as the first sample media data. Then, any piece of first sample media data may be combined with an identifier of the first modality type, thereby obtaining a training task group (the training task group may be referred to as the first training task group). Since a quantity of the first sample media data may not be one, a plurality of first training task groups may be provided. Similarly, second sample media data of the N pieces of sample media data may be combined with a second identifier configured for representing the second modality type, thereby obtaining a second training task group whose modality type is the second modality type; where the second sample media data is any of the N pieces of sample media data whose modality type is the second modality type. The N pieces of sample media data include media data of the first modality type and media data of the second modality type. Any piece of media data whose modality type is the second modality type may be referred to as the second sample media data. Then, any piece of second sample media data may be combined with an identifier of the second modality type, thereby obtaining a training task group (the training task group may be referred to as the second training task group). Since a quantity of the second sample media data may not be one, a plurality of second training task groups may be provided. Cross-modality combination processing may be performed on the first sample media data and the second sample media data based on media source channels respectively corresponding to the first sample media data and the second sample media data, to obtain a training task group whose modality type is the cross-modality type. Further, both the first training task group and the second training task group may be determined as a training task group whose modality type is the single-modality type, and a set including the training task group whose modality type is the cross-modality type and the training task group whose modality type is the single-modality type may be determined as the training task group set.

In an example in which the first modality type is the text modality type and the second modality type includes the image modality type and the video modality type, the N pieces of sample media data may include sample text data 1 (whose modality type is the text modality type), sample text data 2 (whose modality type is the text modality type), sample image data 1 (whose modality type is the image modality type), sample video data 1 (whose modality type is the video modality type), and sample video data 2 (whose modality type is the video modality type). An identifier configured for representing the text modality type may be “text”, an identifier configured for representing the image modality type may be “vision”, and an identifier configured for representing the video modality type may be “video”. Then, the sample text data 1 and the identifier “text” configured for representing the text modality type may be combined, thereby obtaining a training task group <sample text data 1, text>. Alternatively, the sample text data 1 and the identifier “text” configured for representing the text modality type may be combined, thereby obtaining a training task group <sample text data 2, text>. Since both the training task groups <sample text data 1, text>and <sample text data 2, text> include only sample media data of the text modality type, modality types to which the two training task groups belong may be the single-modality type, and the modality types may be the text modality type. Similarly, the sample image data 1 may be combined with the identifier “vision” configured for representing the image modality type, thereby obtaining a training task group <sample image data 1, vision>. The training task group includes only sample media data of the image modality type. Then, a modality type to which the training task group belongs may be the single-modality type, and the modality type may be the image modality type. Similarly, the sample video data 1 and the sample video data 2 may be respectively combined with the identifier “video” configured for representing the video modality type, thereby obtaining training task groups <sample video data 1, video> and <sample video data 2, video>. The two training task groups include only sample media data of the video modality type. Then, modality types to which the training task groups belong may be the single-modality type, and the modality types may be the video modality type. That is, for the sample media data, sample media data of a modality type may be combined with an identifier of a modality type corresponding thereto, thereby obtaining a training task group whose modality type is the single-modality type. Similarly, cross-modality combination may also be performed on sample media data of different modality types, thereby obtaining a training task group whose modality type is the multi-modality type (or referred to as the cross-modality type). In other words, a training task group whose modality type is the single-modality type may include a piece of sample media data and an identifier of a modality type to which the sample media data belongs.

Sample media data from a same media source channel (the media source channel may refer to an acquisition manner or an acquisition position of the sample media data) and of different modality types may be combined. In an example in which one or more pieces of first sample media data and one or more pieces of second sample media data are provided, the one or more pieces of first sample media data include first sample media data Mj (j is a positive integer), and a training task group whose modality type is the cross-modality type includes a training task group corresponding to the first sample media data Mj, some embodiments for performing cross-modality combination processing on the first sample media data and the second sample media data based on media source channels respectively corresponding to the first sample media data and the second sample media data, to obtain a training task group whose modality type is the cross-modality type may be as follows: the media source channel corresponding to the first sample media data Mj may be determined as a target media source channel; then, second sample media data whose media source channel is the target media source channel in the one or more pieces of second sample media data may be determined as associated sample media data corresponding to the first sample media data Mj; and finally, the first sample media data, the associated sample media data, the first identifier, and the second identifier may be combined to obtain the training task group corresponding to the first sample media data Mj.

For example, assuming that the N pieces of sample media data include sample text data a, sample text data b, sample image data a, sample video data h1, and sample video data h2 and both the sample text data a and the sample image data a are from the sample video data h1 (the sample text data a is video description information of the sample video data h1, and the sample image data a is a picture frame of the sample video data h1), it may be determined that the sample text data a and the sample image data a are associated with each other (the sample text data a is associated media data of the sample image data a; similarly, the sample image data a is also associated media data of the sample text data a), the sample text data a and the sample video data h1 are also associated with each other, and the sample image data a and the sample video data h1 are also associated with each other. Based on this, the sample text data a, the sample image data a, and identifiers corresponding thereto (the identifier “text” configured for representing the text modality type and the identifier “vision” configured for representing the image modality type) may be combined, to obtain a training task group <sample text data a-sample image data a, text-vision>, or the sample text data a, the sample video data h1, and identifiers corresponding thereto (the identifier “text” configured for representing the text modality type and the identifier “video” configured for representing the video modality type) may be combined, to obtain a training task group <sample text data a-sample video data h1, text-video>, or the sample image data a, the sample video data h1, and identifiers corresponding thereto (the identifier “vision” configured for representing the image modality type and the identifier “video” configured for representing the video modality type) may be combined, to obtain a training task group <sample image data a-sample video data h1, vision-video>. As can be seen, a training task group whose modality type is the cross-modality type may include two or more pieces of sample media data and identifiers of modality types to which the sample media data belongs.

In summary, in the disclosure, the task group construction processing means correspondingly combining the sample media data and the identifiers of the modality types according to the modality types of the sample media data and the identifiers of the modality types of the sample media data, to obtain a training task group whose modality type is the single-modality type and a training task group of the cross-modality type. In the disclosure, when the sample media data is combined to obtain training task groups, formats of the training task groups are uniform, both the training task group of the single-modality type and the training task group of the multi-modality type are obtained by combining the sample media data and the identifiers configured for representing the modality types and corresponding thereto. Whether the modality type included in the training task group is the single-modality type or the cross-modality type may be clearly indicated by using the identifier configured for representing the modality type, thereby further reflecting whether the modality type to which the training task group belongs is the single-modality type or the cross-modality type. In addition, in the disclosure, the training task group Sᵢ may refer to any training task group in the training task group set. A training task group whose modality type is the single-modality type in the training task group set mainly includes sample media data of one modality type (for example, any one of the text modality type, the image modality type, the video modality type, and the audio modality type), and a quantity of the sample media data is one. Then, for a training task group (e.g., the training task group Sᵢ) in the training task group set, when the training task group is of the single-modality type, the training task group may include only one piece of sample media data. A training task group whose modality type is the cross-modality type in the training task group set may include at least two pieces of sample media data of different modality types, and a quantity of sample media data in each modality type may be at least one. Then, for a training task group (e.g., the training task group Sᵢ) in the training task group set, when the training task group is of the cross-modality type, the training task group may include at least two pieces of sample media data of different modality types.

Operation S102: Perform attention interaction processing on the training task group Sᵢ in a modality representation model to obtain an attention representation vector corresponding to the training task group Sᵢ; the attention interaction processing being configured for making different elements in the training task group Sᵢ fully interact.

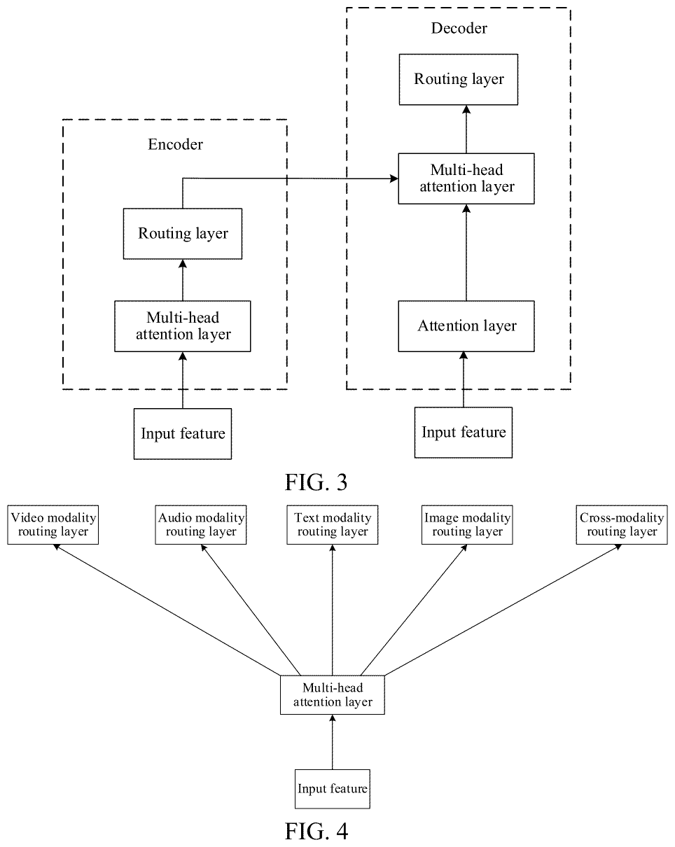

In the disclosure, the modality representation model may be a model based on a transformer architecture. Feature extraction modeling processing may be performed on each training task group by using the transformer architecture. Elements at each feature level in the training task group may fully interact with each other by using the feature extraction modeling processing, so that each element can better pay attention to an element having a relatively strong correlation with the element. Therefore, the feature extraction modeling processing may also be referred to as attention interaction processing. An entire network structure of the transformer architecture completely includes an attention mechanism. More precisely, the transformer architecture includes and only includes self-attention and a feed forward neural network (FFN). In the disclosure, a transformer-based trainable neural network (for example, the modality representation model) may be built in a form of stacked transformers, and the problem of computational context forgetting of a recurrent neural network (RNN) (or a long short term memory (LSTM), a gated recurrent unit (GRU), or the like) may be resolved by using the attention mechanism. To facilitate understanding of the transformer architecture, referring to FIG. 3 together, FIG. 3 is a schematic architectural diagram of a transformer architecture according to some embodiments. As shown in FIG. 3, the transformer architecture includes an encoder and a decoder. The encoder may include a multi-head attention layer and a routing layer. Multi-head attention processing may be performed on input features by using the multi-head attention layer. Routing processing may be performed, by using the routing layer in the encoder, on content processed by the multi-head attention layer. The routing layer herein may be an FFN, which may be a multi-layer fully connected layer. Full connection processing (feature integration processing, which may also be referred to as routing processing) may be performed, by using the routing layer, on the content processed by the multi-head attention layer. Further, a feature obtained through encoding by the encoder (for example, content outputted by the routing layer) may be inputted to the decoder. The feature obtained through encoding by the encoder may be decoded by the decoder. Finally, content outputted through decoding by the decoder may be used as a modality representation vector corresponding to the input feature.

Based on the above, the modality representation model may include a multi-head attention layer, which may be determined as a multi-head self-attention network layer in the disclosure. Herein, performing attention interaction processing on the training task group Sᵢ in the modality representation model may mean performing attention interaction processing on the training task group Sᵢ in the multi-head self-attention network layer. A implementation thereof may be as follows: in the modality representation model, feature extraction processing may be performed on the sample media data included in the training task group Sᵢ by using a feature extraction network layer, thereby obtaining a media feature corresponding to the training task group Sᵢ. Further, multi-head self-attention processing may be performed on the media feature corresponding to the training task group Sᵢ by using a multi-head self-attention network layer in the modality representation model, thereby obtaining the attention representation vector corresponding to the training task group Sᵢ.

The feature extraction network layer herein may be an embedding layer, and a feature of the sample media data in the training task group may be extracted by using the embedding layer, to obtain the media feature. The media feature herein may be determined based on a modality type to which the sample media data belongs. When the sample media data is of the text modality type, the media feature of the sample media data may refer to a word feature corresponding to each text word. When the sample media data is of the image modality type, the media feature of the sample media data may refer to a pixel feature (an image may be divided into a plurality of pixel grids, and the media feature may include a pixel feature corresponding to each pixel grid). When the sample media data is of the audio modality type, the media feature of the sample media data may be a phoneme feature. When the sample media data is of the video modality type, the media feature of the sample media data may include frame features corresponding to video frames. When the sample media data is of the cross-modality type, the media feature of the training task group may include media features of sample media data of different modality types, for example, may include two or more of a word feature, a pixel feature, a phoneme feature, and a frame feature.

The multi-head self-attention network layer may include Q (Q is a positive integer) self-attention sub-network layers, and an output result of the multi-head self-attention network layer may be obtained by fusing output results of the self-attention sub-network layers. In an example in which the Q self-attention sub-network layers include a self-attention sub-network layer Vₖ (k is a positive integer), some embodiments for performing, by using a multi-head self-attention network layer in the modality representation model, multi-head self-attention processing on the media feature corresponding to the training task group Sᵢ to obtain the attention representation vector corresponding to the training task group Sᵢ may be as follows: an attention parameter matrix included in the self-attention sub-network layer Vₖ may be acquired, and then operation processing may be performed on the attention parameter matrix included in the self-attention sub-network layer Vₖ and the media feature corresponding to the training task group Sᵢ, thereby obtaining a linear transformation matrix corresponding to the attention parameter matrix. Further, feature integration processing may be performed on the linear transformation matrix by using a fully connected component in the self-attention sub-network layer Vₖ, thereby obtaining an attention representation sub-vector corresponding to the self-attention sub-network layer Vₖ; and when attention representation sub-vectors respectively corresponding to the Q self-attention sub-network layers are determined, the Q attention representation sub-vectors may be fused, thereby obtaining the attention representation vector corresponding to the training task group Sᵢ.

In a self-attention sub-network layer, the included attention parameter matrix may include W^{Q}, W^{K}, and W^{V} matrices. The media feature corresponding to the training task group Sᵢ may be multiplied with W^{Q}, W^{K}, and W_{V} respectively to obtain a linear transformation matrix corresponding to the W^{Q} matrix, a linear transformation matrix corresponding to the W^{K} matrix, and a linear transformation matrix corresponding to the W_{V} matrix. Multiplication operation processing may be performed on the linear transformation matrix W^{Q} and the linear transformation matrix W^{K}. An operation result of the multiplication operation of the two matrices may be inputted to a fully connected layer (e.g., a Softmax layer) for full connection processing (for example, feature integration processing). Another multiplication operation may be performed on a result obtained through the full connection processing and the linear transformation matrix W^{V}, and an operation result obtained by performing another multiplication operation with the linear transformation matrix W^{V} may be used as an output result of the self-attention sub-network layer (for example, an attention representation sub-vector). Each self-attention sub-network layer includes different W^{Q}, W^{K}, and W^{V} matrices. Different attention representation sub-vectors may be obtained by using the same principle, and finally, these different attention representation sub-vectors may be fused to obtain a final attention representation vector.

A implementation for obtaining the final attention representation vector based on the attention representation sub-vectors of the self-attention sub-network layers may be shown in Formula (1):

$${E}_{attn} = MSA ( Q , K , V ) = Concat ( {Head}_{1} , {Head}_{2} … {Head}_{{H}_{n}} ) \qquad Formula ( 1 )$$

where Eₐₜₜₙ may be configured for representing the final attention representation vector; Head_{H}_{ₙ} may be configured for representing an attention representation sub-vector of a self-attention sub-network layer Hn. Concat ( ) may be configured for representing concatenation processing. That is, the attention representation sub-vectors may be fused (concatenated), and the attention representation vector may be obtained after the fusion (concatenation).

Operation S103: Determine, in a single-modality routing layer and a cross-modality routing layer that are included in the modality representation model, a target routing layer matching the modality type to which the training task group Sᵢ belongs, and perform feature prediction processing on the attention representation vector corresponding to the training task group Si based on the target routing layer to obtain a predicted modality representation vector corresponding to the training task group Sᵢ.

In the disclosure, based on the above, the encoder and the decoder included in the modality representation model may both include a multi-head attention layer and a routing layer. The routing layer may perform feature integration processing (for example, routing processing, which is referred to as feature prediction processing in the disclosure) on attention representation vectors outputted by the multi-head attention layer, to obtain a final modality representation vector. The modality representation vector may be a feature obtained after inference understanding is performed on the training task group. To improve accuracy of understanding of data of different modality types, in the disclosure, the routing layers in the modality representation model may be set to different modality routing layers, and the modality routing layers correspond to different modality types. For example, the routing layers may be set to a text modality routing layer, an image modality routing layer, an audio modality routing layer, a video modality routing layer, and a cross-modality routing layer. The text modality routing layer may be configured to process data whose modality type is the text modality type, the image modality routing layer may be configured to process data whose modality type is the image modality type, the audio modality routing layer may be configured to process data whose modality type is the audio modality type, the video modality routing layer may be configured to process data whose modality type is the video modality type, and the cross-modality routing layer may process data whose modality type is the cross-modality type. The text modality routing layer, the image modality routing layer, the audio modality routing layer, and the video modality routing layer may all be understood as a single-modality routing layer. That is, the modality representation model may include both a single-modality routing layer and a cross-modality routing layer. Based on this, for the training task group Sᵢ, after the attention representation vector corresponding to the training task group Sᵢ is determined, in the single-modality routing layer and the cross-modality routing layer included in the modality representation model, a modality routing layer matching the modality type to which the training task group Sᵢ belongs is determined as a target routing layer, and feature prediction processing is performed on the attention representation vector corresponding to the training task group Sᵢ based on the target routing layer, to obtain a modality representation vector (a predicted modality representation vector) corresponding to the training task group Sᵢ.

In an example in which the single-modality type includes a first modality type and a second modality type and the single-modality routing layer includes a first modality sub-routing layer corresponding to the first modality type and a second modality sub-routing layer corresponding to the second modality type, some embodiments for determining, in the single-modality routing layer and the cross-modality routing layer included in the modality representation model, a target routing layer matching the modality type to which the training task group Sᵢ belongs may be as follows: if the modality type to which the training task group Sᵢ belongs is the cross-modality type, the cross-modality routing layer included in the modality representation model may be determined as the target routing layer matching the modality type to which the training task group Sᵢ belongs; if the modality type to which the training task group Sᵢ belongs is the first modality type, the first modality sub-routing layer corresponding to the first modality type may be determined as the target routing layer matching the modality type to which the training task group Sᵢ belongs; and if the modality type to which the training task group Sᵢ belongs is the second modality type, the second modality sub-routing layer corresponding to the second modality type may be determined as the target routing layer matching the modality type to which the training task group Si belongs.

The first modality type and the second modality type may refer to different modality types. For example, the first modality type may refer to one or more of the text modality type, the image modality type, the audio modality type, and the video modality type, and the second modality type may refer to remaining modality types other than the first modality type among the text modality type, the image modality type, the audio modality type, and the video modality type. Then, when the modality type to which the training task group Sᵢ belongs is the text modality type, the text modality routing layer may be determined as the target routing layer corresponding to the training task group Sᵢ. When the modality type to which the training task group Sᵢ belongs is the image modality type, the image modality routing layer may be determined as the target routing layer corresponding to the training task group Sᵢ. When the modality type to which the training task group Sᵢ belongs is the audio modality type, the audio modality routing layer may be determined as the target routing layer corresponding to the training task group Sᵢ. When the modality type to which the training task group Sᵢ belongs is the video modality type, the video modality routing layer may be determined as the target routing layer corresponding to the training task group Sᵢ. When the modality type to which the training task group Si belongs is the cross-modality type, the cross-modality routing layer may be determined as the target routing layer corresponding to the training task group Sᵢ.

To facilitate understanding of the routing distribution mechanism, referring to FIG. 4 together, FIG. 4 is a schematic diagram of a routing distribution architecture according to some embodiments. As shown in FIG. 4, the single-modality routing layer may be a text modality routing layer, an image modality routing layer, an audio modality routing layer, or a video modality routing layer, and may be configured to perform routing processing on data of a corresponding modality type. When an input feature is a media feature corresponding to the text modality type, an attention representation vector, after being outputted by using the multi-head attention layer, may be distributed to the text modality routing layer and be routed by the text modality routing layer performs routing processing thereon. When the input feature is a media feature corresponding to the image modality type, an attention representation vector, after being outputted by using the multi-head attention layer, may be distributed to the image modality routing layer, and the image modality routing layer performs routing processing thereon. When the input feature is a media feature corresponding to the audio modality type, an attention representation vector, after being outputted by using the multi-head attention layer, may be distributed to the audio modality routing layer, and the audio modality routing layer performs routing processing thereon. When the input feature is a media feature corresponding to the video modality type, an attention representation vector, after being outputted by using the multi-head attention layer, may be distributed to the video modality routing layer, and the video modality routing layer performs routing processing thereon. When the input feature is a media feature corresponding to the multi-modality type, an attention representation vector, after being outputted by using the multi-head attention layer, may be distributed to the cross-modality routing layer, and the cross-modality routing layer performs routing processing thereon. Each modality routing layer may be a fully connected layer of a multi-layer structure.

Operation S104: Optimize, when a predicted modality representation vector corresponding to each training task group in the training task group set is determined, the single-modality routing layer based on the predicted modality representation vector corresponding to the training task group whose modality type is the single-modality type, and optimize the cross-modality routing layer based on the predicted modality representation vector corresponding to the training task group whose modality type is the cross-modality type; an optimized single-modality routing layer being configured to perform feature prediction processing on a task group whose modality type is the single-modality type, and an optimized cross-modality routing layer being configured to perform feature prediction processing on a task group whose modality type is the cross-modality type.

In the disclosure, when a predicted modality representation vector corresponding to each training task group in the training task group set is determined, the corresponding modal routing layer may be trained and optimized by the predicted modality representation vector corresponding to the training task group of the corresponding modal type. For example, the single-modality routing layer may be optimized based on the predicted modality representation vector corresponding to the training task group whose modality type is the single-modality type, and the cross-modality routing layer may be optimized based on the predicted modality representation vector corresponding to the training task group whose modality type is the cross-modality type. The optimized single-modality routing layer may be configured to perform feature prediction processing on a task group whose modality type is the single-modality type. The optimized cross-modality routing layer may be configured to perform feature prediction processing on a task group whose modality type is the cross-modality type. The text modality routing layer may be trained and optimized based on a predicted modality representation vector corresponding to a training task group whose modality type is the text modality type, the image modality routing layer may be trained and optimized based on a predicted modality representation vector corresponding to a training task group whose modality type is the image modality type, the audio modality routing layer may be trained and optimized based on a predicted modality representation vector corresponding to a training task group whose modality type is the audio modality type, and the video modality routing layer may be trained and optimized based on a predicted modality representation vector corresponding to a training task group whose modality type is the video modality type. A trained and optimized text modality routing layer may perform feature prediction processing on text data, a trained and optimized image modality routing layer may perform feature prediction processing on image data, a trained and optimized audio modality routing layer may perform feature prediction processing on audio data, and a trained and optimized video modality routing layer may perform feature prediction processing on video data.

For example, a target task group of the cross-modality type may be processed based on an optimized cross-modality routing layer. A target task group configured for describing to-be-classified media data may be acquired. The target task group includes at least two pieces of media data of different modality types. Then, attention interaction processing may be performed on the target task group in the modality representation model, thereby obtaining an attention representation vector corresponding to the target task group. Further, in the optimized cross-modality routing layer, feature prediction processing may be performed on the attention representation vector corresponding to the target task group, thereby obtaining a predicted modality representation vector corresponding to the target task group. Then, category recognition processing may be performed on the predicted modality representation vector corresponding to the target task group, thereby obtaining a media category to which the to-be-classified media data belongs. After the media category to which the to-be-classified media data belongs is determined, the to-be-classified media data may be filed according to the media category.

A scenario in which the media data is filed is used as an example herein to describe a scenario to which some embodiments may be applied. Assuming that the to-be-classified media data is video data, text data and image data from the video data may be used as a task group, and then the task group is inferred and understood by using the trained and optimized cross-modality routing layer, to obtain an accurate modality representation vector of the video data. A media category (such as a dance category, a competition category, or a gymnastics category) to which the video data belongs may be determined based on the modality representation vector of the video data. That is, the video data may be accurately filed by using the media category to which the video data belongs.

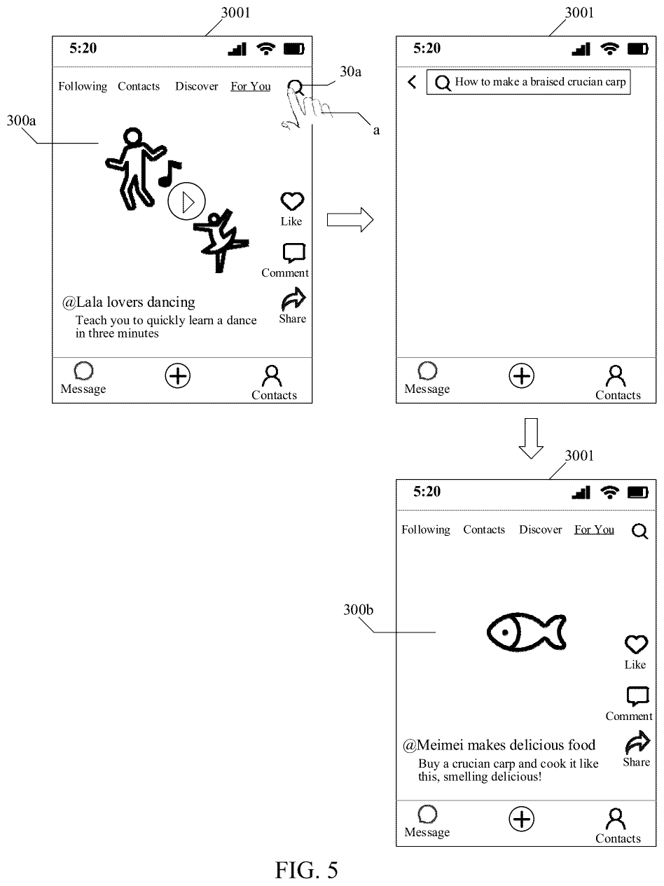

Certainly, for the method provided in some embodiments, an application scenario is not limited thereto. For example, the method may further be applied to a scenario of multi-modality content retrieval, a scenario of media data recommendation, and the like. For ease of understanding, referring to FIG. 5 together, FIG. 5 is a schematic diagram of a scenario of media data retrieval according to some embodiments. As shown in FIG. 5, in a video display interface 3001, video data currently exposed to an object a is video data 300a (the video data 300a is created by an object named “Lala loves dancing”, and a video copy of the video data 300a is “Teach you to quickly learn a dance in three minutes”). A like control, a comment control, and a share control are displayed in the video display interface 3001, and may be configured for the object to like, comment, and share the video data. The video display interface 3001 further includes a search control 30a, which may be configured for the object a to search for related content. As shown in FIG. 3, after the object a generates a trigger operation on the search control 30a, the terminal device may display an input box in the video display interface 3001 in response to the trigger operation, and the object a may enter, in the input box, content that the object a wants to look up.

As shown in FIG. 3, the object a enters text data “How to make a braised crucian carp” in the input box, and the terminal device may acquire the text data “How to make a braised crucian carp” entered by the object a. The terminal device may transmit the text data “How to make a braised crucian carp” to the service server. The service server may perform inference understanding on the text data “How to make a braised crucian carp” by using a trained and optimized modality representation model. The attention representation vector corresponding to the text data “How to make a braised crucian carp” may be outputted by using the multi-head self-attention network layer in the modality representation model, the attention representation vector may be distributed to the text modality routing layer, and a modality representation vector corresponding to the text data “How to make a braised crucian carp” may be outputted by using the text modality routing layer. Based on the modality representation vector corresponding to the text data, video data related thereto may be found. As shown in FIG. 3, assuming that the video data related thereto is video data 300b (the video data 300b is created by an object named “Meimei makes delicious food”, and video text of the video data 300b is “Buy a crucian carp and cook it like this, smelling delicious!”), the service server may return the video data 300b to the terminal device, and the terminal device may display the video data 300b in the video display interface 3001.

After determining a modality representation vector corresponding to the text data, the service server may determine, based on a similarity between different vectors, whether the two pieces of data are associated. For example, for the modality representation vector corresponding to the text data “How to make a braised crucian carp”, modality representation vectors of candidate video data may be acquired first, and then a similarity between the modality representation vector corresponding to the text data “How to make a braised crucian carp” and the modality representation vector of each piece of the candidate video data is calculated. When the similarity is greater than a similarity threshold, it may be determined that the candidate video data is associated video data of the text data “How to make a braised crucian carp”.

In some embodiments, a universal modality representation model based on a modality routing mechanism is provided, which may provide corresponding data processing functions for data whose modality type is the single-modality type and data whose modality type is the cross-modality type. In the disclosure, a modality representation model may be trained by using a training task group set including a single-modality type and a cross-modality type. The modality representation model includes a single-modality routing layer and a cross-modality routing layer. The single-modality routing layer may perform feature prediction processing on data (an attention representation vector) whose modality type is the single-modality type. The cross-modality routing layer may perform feature prediction processing on data (an attention representation vector) whose modality type is the cross-modality type. During training and optimization, the single-modality routing layer may be optimized based on a predicted modality representation vector corresponding to a training task group whose modality type is the single-modality type, and the cross-modality routing layer may be optimized by using a predicted modality representation vector corresponding to a training task group whose modality type is the cross-modality type. Based on this, the single-modality routing layer and the cross-modality routing layer in the modality representation model may be trained and optimized at the same time. In addition, during training and optimization, training and optimization are separately performed based on data of different modality types. Data of any modality type does not may be lost, and performance of the single-modality routing layer and the cross-modality routing layer can be maintained at the same time, thereby improving universality and flexibility of the modality representation model for the single-modality type and the cross-modality type. In summary, in the disclosure, a routing distribution mechanism may be configured in the modality representation model, and routing layers are classified into a single-modality routing layer and a cross-modality routing layer. Different routing layers may process the data of different modality types, and the data of different modality types is respectively trained and optimized during training. Each routing layer may retain only related information of a current modality type, so that data of any modality type does not may be discarded, and representation vectors of the cross-modality type and the single-modality type can be simultaneously outputted, thereby well improving accuracy of representation results of data of various modality types. In summary, in the disclosure, universality of a modality representation model and accuracy of a modality representation result in a modality representation service can be improved.

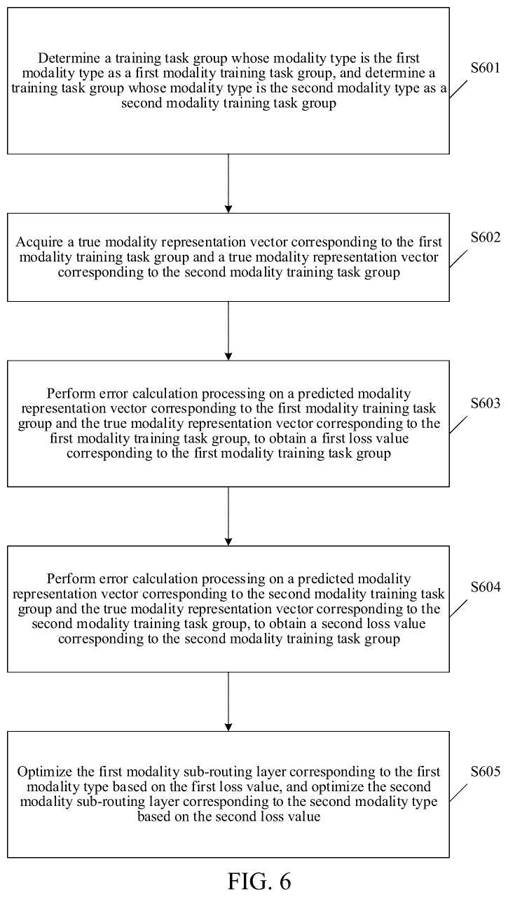

Further, referring to FIG. 6, FIG. 6 is a schematic flowchart of optimizing a single-modality routing layer according to some embodiments. The process may correspond to the process of optimizing the single-modality routing layer based on the predicted modality representation vector corresponding to the training task group whose modality type is the single-modality type in the foregoing embodiment corresponding to FIG. 2. The process is a process described with an example in which the single-modality type includes a first modality type and a second modality type and the single-modality routing layer includes a first modality sub-routing layer corresponding to the first modality type and a second modality sub-routing layer corresponding to the second modality type. As shown in FIG. 6, the process may include at least the following operation S601 to operation S605.

Operation S601: Determine a training task group whose modality type is the first modality type as a first modality training task group, and determine a training task group whose modality type is the second modality type as a second modality training task group.

To facilitate distinction, the training task group whose modality type is the first modality type may be determined as the first modality training task group, and the training task group whose modality type is the second modality type may be determined as the second modality training task group.

Operation S602: Acquire a true modality representation vector corresponding to the first modality training task group and a true modality representation vector corresponding to the second modality training task group.

The true modality representation vector corresponding to the first modality training task group and the true modality representation vector corresponding to the second modality training task group may be acquired. The true modality representation vector may be a modality representation vector that is used as a training tag and true.

Operation S603: Perform error calculation processing on a predicted modality representation vector corresponding to the first modality training task group and the true modality representation vector corresponding to the first modality training task group, to obtain a first loss value corresponding to the first modality training task group.

Error calculation processing may be performed on the predicted modality representation vector corresponding to the first modality training task group and the true modality representation vector corresponding to the first modality training task group (for example, calculate an error value between the predicted modality representation vector and the true modality representation vector), thereby obtaining the first loss value corresponding to the first modality training task group. In an example in which the first modality type is the text modality type, the first modality training task group may be a text word sequence, the predicted modality representation vector corresponding to the first modality training task group includes predicted representation features respectively corresponding to text words in the text word sequence, and the true modality representation vector corresponding to the first modality training task group includes true representation features respectively corresponding to the text words in the text word sequence. In this case, some embodiments for performing error calculation processing on a predicted modality representation vector corresponding to the first modality training task group and the true modality representation vector corresponding to the first modality training task group, to obtain a first loss value corresponding to the first modality training task group may be as follows: a masked text word may be acquired from the text words included in the text word sequence; where the masked text word is a text word that has been masked; then, a predicted representation feature corresponding to the masked text word may be acquired from the predicted modality representation vector corresponding to the first modality training task group, and a true representation feature corresponding to the masked text word may be acquired from the true modality representation vector corresponding to the first modality training task group; a first feature similarity between the predicted representation feature corresponding to the masked text word and the true representation feature corresponding to the masked text word may be determined; then, the first feature similarity may be determined as the first loss value corresponding to the first modality training task group.

For the text word sequence, in the disclosure, a text word may be masked by using a masking policy. For example, a text word in the text word sequence and having a noun attribute, a verb attribute, or a position attribute may be masked. The predicted modality representation vector outputted by the modality representation model includes a predicted representation feature corresponding to the masked text word. The true modality representation vector also includes a true representation feature corresponding to the masked text word. A similarity between the predicted representation feature and the true representation feature may be calculated, and the similarity between the predicted representation feature and the true representation feature may be used as the first loss value corresponding to the first modality training task group.

Similarly, when the first modality type is the image modality type or the audio modality type, some elements in the first modality training task group may be masked. For example, when the first modality type is the image modality type, the first modality training task group may be image data, some pixel regions in the image data may be masked (a pixel region with a higher mutual intersection ratio may be masked), the predicted modality representation vector outputted by the modality representation model includes a predicted representation feature corresponding to the masked pixel region, and the true modality representation vector also includes a true representation feature corresponding to the masked pixel region. Similarly, a similarity between the predicted representation feature and the true representation feature may be calculated, and the similarity between the predicted representation feature and the true representation feature may be used as the first loss value corresponding to the first modality training task group.

Alternatively, the first modality training task group may not be masked, the similarity between the predicted modality representation vector and the true modality representation vector may be directly calculated, and an obtained overall similarity may be used as a final first loss value. In addition to the manner of calculating the similarity to obtain the first loss value, a loss value between a predicted value and a true value may also be calculated by using a feature regression or region-based classification objective. A manner of calculating the loss value based on the predicted value and the true value is not limited in the disclosure.

Operation S604: Perform error calculation processing on a predicted modality representation vector corresponding to the second modality training task group and the true modality representation vector corresponding to the second modality training task group, to obtain a second loss value corresponding to the second modality training task group.

A implementation for performing error calculation processing on a predicted modality representation vector corresponding to the second modality training task group and the true modality representation vector corresponding to the second modality training task group, to obtain a second loss value corresponding to the second modality training task group may be obtained with reference to the above description of determining the first loss value, and principles of the two are identical. Details are not described herein again.

Operation S605: Optimize the first modality sub-routing layer corresponding to the first modality type based on the first loss value, and optimize the second modality sub-routing layer corresponding to the second modality type based on the second loss value.

The first modality sub-routing layer corresponding to the first modality type may be optimized based on the first loss value, and the second modality sub-routing layer corresponding to the second modality type may be optimized based on the second loss value. In other words, modality sub-routing layers of different modality types may be optimized based on loss values obtained from predicted values of the corresponding modality types. Parameters of the modality sub-routing layers may be adjusted based on the loss values until the loss values satisfy a convergence condition. The convergence condition herein may mean that a quantity of iterations reaches an iteration threshold (the iteration threshold may be set based on an actual service requirement), or may mean that a loss value is less than the loss threshold. The convergence condition may be correspondingly set based on a service requirement, which is not limited in the disclosure and is stated herein.

In some embodiments, a routing distribution mechanism may be configured in the modality representation model, and routing layers are classified into a single-modality routing layer and a cross-modality routing layer. Different routing layers may process data of different modality types, and the data of different modality types is respectively trained and optimized during training. Each routing layer may retain only related information of a current modality type, so that data of any modality type does not may be discarded, and representation vectors of the cross-modality type and the single-modality type can be simultaneously outputted, thereby well improving accuracy of representation results of data of various modality types.

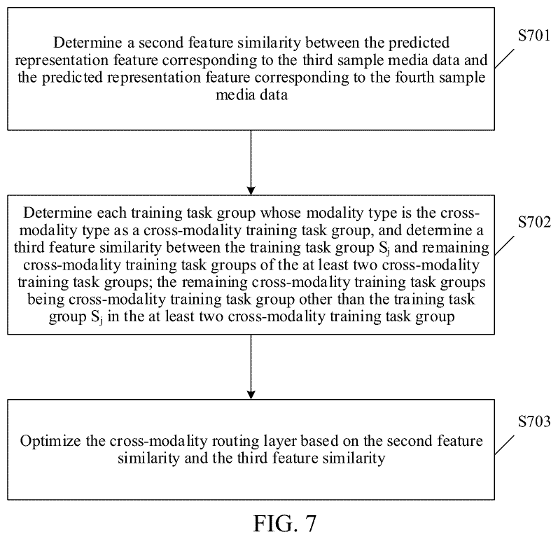

Further, referring to FIG. 7, FIG. 7 is a schematic flowchart of optimizing a cross-modality routing layer according to some embodiments. The process may correspond to the process of optimizing the cross-modality routing layer based on the predicted modality representation vector corresponding to the training task group whose modality type is the cross-modality type in the foregoing embodiment corresponding to FIG. 2. The process is a process described with an example in which the training task group set includes at least two training task groups whose modality types are the cross-modality type, the at least two training task groups whose modality types are the cross-modality type include a training task group Sⱼ (j is a positive integer), and the training task group Sⱼ includes third sample media data whose modality type is the first modality type and fourth sample media data whose modality type is the second modality type. In this case, a predicted modality representation vector corresponding to the training task group Sⱼ may include a predicted representation feature corresponding to the third sample media data and a predicted representation feature corresponding to the fourth sample media data. As shown in FIG. 7, the process may include at least the following operation S701 to operation S703.

Operation S701: Determine a second feature similarity between the predicted representation feature corresponding to the third sample media data and the predicted representation feature corresponding to the fourth sample media data.

A task of cross-modality retrieval is that after an object enters information (such as text data), a platform may recall image/video/audio content associated with the information. Therefore, a core idea of cross-modality retrieval is to perform alignment and consistency between different modalities, for example, matched pictures and text content, audio content, or video content are closest and similar in a feature space, and unmatched pictures and text content, audio content, or video content are inconsistent in the feature space. Based on this, for training task groups including different modality types, the second feature similarity between the predicted representation feature corresponding to the third sample media data and the predicted representation feature corresponding to the fourth sample media data may be determined. The second feature similarity may be as large as possible, so that matched text, images, audios, and videos are consistent in the feature space.

Operation S702: Determine each training task group whose modality type is the cross-modality type as a cross-modality training task group, and determine a third feature similarity between the training task group Sⱼ and remaining cross-modality training task groups of the at least two cross-modality training task groups; the remaining cross-modality training task groups being cross-modality training task group other than the training task group Sⱼ in the at least two cross-modality training task group.

Based on the above, a similarity between sample media data with different media source channels may be controlled to be as small as possible. Then, a third feature similarity generated between the training task group Sⱼ and another cross-modality training task group may be gradually reduced.

Operation S703: Optimize the cross-modality routing layer based on the second feature similarity and the third feature similarity.

Based on the above, in the disclosure, the second feature similarity may be maximized by continuously adjusting a parameter of the cross-modality routing layer, and the third feature similarity may be minimized by continuously adjusting the parameter of the cross-modality routing layer, until it is determined that the cross-modality routing layer satisfies the convergence condition when the second feature similarity is a maximum value and the third feature similarity is a minimum value, the parameter of the cross-modality routing layer may not be adjusted any more, and it is determined that the cross-modality routing layer is optimal.

In some embodiments, a routing distribution mechanism may be configured in the modality representation model, and routing layers are classified into a single-modality routing layer and a cross-modality routing layer. Different routing layers may process data of different modality types, and the data of different modality types is respectively trained and optimized during training. Each routing layer may retain only related information of a current modality type, so that data of any modality type does not may be discarded, and representation vectors of the cross-modality type and the single-modality type can be simultaneously outputted, thereby well improving accuracy of representation results of data of various modality types.

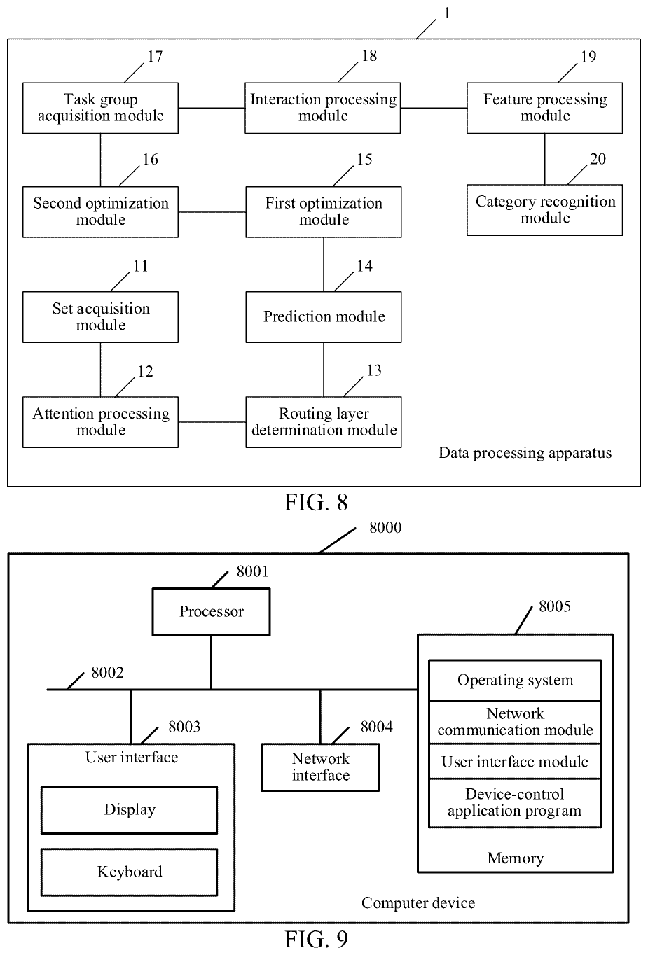

Further, referring to FIG. 8, FIG. 8 is a schematic structural diagram of a data processing apparatus according to some embodiments. The data processing apparatus may be a computer program (including program code) run on a computer device. For example, the data processing apparatus is application software. The data processing apparatus may be configured to perform the method shown in FIG. 2. As shown in FIG. 8, the data processing apparatus 1 may include: a set acquisition module 11, an attention processing module 12, a routing layer determination module 13, a prediction module 14, a first optimization module 15, and a second optimization module 16.

The set acquisition module 11 is configured to acquire a training task group set; the training task group set including a training task group Sᵢ, i being a positive integer; a modality type to which the training task group Sᵢ belongs being a single-modality type or a cross-modality type; when the modality type to which the training task group Sᵢ belongs is the single-modality type, the training task group Sᵢ including a piece of sample media data; and when the modality type to which the training task group Si belongs is the cross-modality type, the training task group Sᵢ including at least two pieces of sample media data of different modality types.

The attention processing module 12 is configured to perform attention interaction processing on the training task group Sᵢ in a modality representation model to obtain an attention representation vector corresponding to the training task group Sᵢ; the attention interaction processing being configured for making different elements in the training task group Sᵢ fully interact.

The routing layer determination module 13 is configured to determine, in a single-modality routing layer and a cross-modality routing layer that are included in the modality representation model, a target routing layer matching the modality type to which the training task group Sᵢ belongs.

The prediction module 14 is configured to perform feature prediction processing on the attention representation vector corresponding to the training task group Sᵢ based on the target routing layer to obtain a predicted modality representation vector corresponding to the training task group Sᵢ.

The first optimization module 15 is configured to optimize, when a predicted modality representation vector corresponding to each training task group in the training task group set is determined, the single-modality routing layer based on the predicted modality representation vector corresponding to the training task group whose modality type is the single-modality type.

The second optimization module 16 is configured to optimize the cross-modality routing layer based on the predicted modality representation vector corresponding to the training task group whose modality type is the cross-modality type. An optimized single-modality routing layer is configured to perform feature prediction processing on a task group whose modality type is the single-modality type, and an optimized cross-modality routing layer is configured to perform feature prediction processing on a task group whose modality type is the cross-modality type.

For implementations of the set acquisition module 11, the attention processing module 12, the routing layer determination module 13, the prediction module 14, the first optimization module 15, and the second optimization module 16, refer to the descriptions of operation S101 to operation S104 in the foregoing embodiment corresponding to FIG. 2. Details are not described herein again

In some embodiments, an implementation in which the set acquisition module 11 acquires a training task group set includes:
acquiring N pieces of sample media data; N being a positive integer, and a modality type to which one of the N pieces of media data belongs is either a first modality type or a second modality type; the first modality type being different from the second modality type; and
performing task group construction processing on the N pieces of sample media data based on the modality type to which each of the N pieces of sample media data belongs, to obtain the training task group set.

In some embodiments, an implementation in which the set acquisition module 11 performs task group construction processing on the N pieces of sample media data based on the modality type to which each of the N pieces of sample media data belongs, to obtain the training task group set includes:
combining first sample media data of the N pieces of sample media data with a first identifier configured for representing the first modality type, to obtain a first training task group whose modality type is the first modality type; the first sample media data being any of the N pieces of sample media data whose modality type is the first modality type;
combining second sample media data of the N pieces of sample media data with a second identifier configured for representing the second modality type, to obtain a second training task group whose modality type is the second modality type; the second sample media data being any of the N pieces of sample media data whose modality type is the second modality type;
performing cross-modality combination processing on the first sample media data and the second sample media data based on media source channels respectively corresponding to the first sample media data and the second sample media data, to obtain a training task group whose modality type is the cross-modality type; and
determining both the first training task group and the second training task group as a training task group whose modality type is the single-modality type, and determining a set including the training task group whose modality type is the cross-modality type and the training task group whose modality type is the single-modality type as the training task group set.

In some embodiments, one or more pieces of first sample media data and one or more pieces of second sample media data are provided; the one or more pieces of first sample media data including first sample media data Mⱼ, j being a positive integer; the training task group whose modality type is the cross-modality type includes a training task group corresponding to the first sample media data Mⱼ; and
an implementation in which the set acquisition module 11 performs cross-modality combination processing on the first sample media data and the second sample media data based on media source channels respectively corresponding to the first sample media data and the second sample media data, to obtain a training task group whose modality type is the cross-modality type includes:
determining the media source channel corresponding to the first sample media data Mⱼ as a target media source channel;

determining second sample media data whose media source channel is the target media source channel in the one or more pieces of second sample media data as associated sample media data corresponding to the first sample media data Mⱼ; and
combining the first sample media data, the associated sample media data, the first identifier, and the second identifier to obtain the training task group corresponding to the first sample media data Mⱼ.

In some embodiments, an implementation in which the attention processing module 12 performs attention interaction processing on the training task group Sᵢ in a modality representation model to obtain an attention representation vector corresponding to the training task group Sᵢ includes:
performing, in the modality representation model by using a feature extraction network layer, feature extraction processing on the sample media data included in the training task group Sᵢ, to obtain a media feature corresponding to the training task group Sᵢ; and
performing, by using a multi-head self-attention network layer in the modality representation model, multi-head self-attention processing on the media feature corresponding to the training task group Sᵢ to obtain the attention representation vector corresponding to the training task group Sᵢ.

In some embodiments, the multi-head self-attention network layer in the modality representation model includes Q self-attention sub-network layers; Q being a positive integer; the Q self-attention sub-network layers including a self-attention sub-network layer Vₖ, k being a positive integer; and
an implementation in which the attention processing module 12 performs, by using a multi-head self-attention network layer in the modality representation model, multi-head self-attention processing on the media feature corresponding to the training task group Sᵢ to obtain the attention representation vector corresponding to the training task group Sᵢ includes:
acquiring an attention parameter matrix included in the self-attention sub-network layer Vₖ, performing operation processing on the attention parameter matrix included in the self-attention sub-network layer Vₖ and the media feature corresponding to the training task group Sᵢ, to obtain a linear transformation matrix corresponding to the attention parameter matrix;
performing, by using a fully connected component in the self-attention sub-network layer Vₖ, feature integration processing on the linear transformation matrix, to obtain an attention representation sub-vector corresponding to the self-attention sub-network layer Vₖ; and
fusing, when attention representation sub-vectors respectively corresponding to the Q self-attention sub-network layers are determined, the Q attention representation sub-vectors, to obtain the attention representation vector corresponding to the training task group Sᵢ.

In some embodiments, the single-modality type includes a first modality type and a second modality type; the single-modality routing layer includes a first modality sub-routing layer corresponding to the first modality type and a second modality sub-routing layer corresponding to the second modality type; and
an implementation in which the routing layer determination module 13 determines, in a single-modality routing layer and a cross-modality routing layer that are included in the modality representation model, a target routing layer matching the modality type to which the training task group Sᵢ belongs includes:
determining, if the modality type to which the training task group Si belongs is the cross-modality type, the cross-modality routing layer included in the modality representation model as the target routing layer matching the modality type to which the training task group Sᵢ belongs;
determining, if the modality type to which the training task group Sᵢ belongs is the first modality type, the first modality sub-routing layer corresponding to the first modality type as the target routing layer matching the modality type to which the training task group Si belongs; and
determining, if the modality type to which the training task group Sᵢ belongs is the second modality type, the second modality sub-routing layer corresponding to the second modality type as the target routing layer matching the modality type to which the training task group Sᵢ belongs.

In some embodiments, the single-modality type includes a first modality type and a second modality type; the single-modality routing layer includes a first modality sub-routing layer corresponding to the first modality type and a second modality sub-routing layer corresponding to the second modality type; and
an implementation in which the first optimization module 15 optimizes the single-modality routing layer based on the predicted modality representation vector corresponding to the training task group whose modality type is the single-modality type includes:
determining a training task group whose modality type is the first modality type as a first modality training task group, and determining a training task group whose modality type is the second modality type as a second modality training task group;
acquiring a true modality representation vector corresponding to the first modality training task group and a true modality representation vector corresponding to the second modality training task group;

performing error calculation processing on a predicted modality representation vector corresponding to the first modality training task group and the true modality representation vector corresponding to the first modality training task group, to obtain a first loss value corresponding to the first modality training task group;
performing error calculation processing on a predicted modality representation vector corresponding to the second modality training task group and the true modality representation vector corresponding to the second modality training task group, to obtain a second loss value corresponding to the second modality training task group; and
optimizing the first modality sub-routing layer corresponding to the first modality type based on the first loss value, and optimizing the second modality sub-routing layer corresponding to the second modality type based on the second loss value.

In some embodiments, the first modality type is a text modality type, and the first modality training task group is a text word sequence; the predicted modality representation vector corresponding to the first modality training task group includes predicted representation features respectively corresponding to text words in the text word sequence; the true modality representation vector corresponding to the first modality training task group includes true representation features respectively corresponding to the text words in the text word sequence; and
an implementation in which the first optimization module 15 performs error calculation processing on a predicted modality representation vector corresponding to the first modality training task group and the true modality representation vector corresponding to the first modality training task group, to obtain a first loss value corresponding to the first modality training task group includes:
acquiring a masked text word from the text words included in the text word sequence; the masked text word being a text word that has been masked;
acquiring a predicted representation feature corresponding to the masked text word from the predicted modality representation vector corresponding to the first modality training task group, and acquiring a true representation feature corresponding to the masked text word from the true modality representation vector corresponding to the first modality training task group;
determining a first feature similarity between the predicted representation feature corresponding to the masked text word and the true representation feature corresponding to the masked text word; and
determining the first feature similarity as the first loss value corresponding to the first modality training task group.

In some embodiments, the training task group set includes at least two training task groups whose modality types are the cross-modality type; the at least two training task groups whose modality types are the cross-modality type including a training task group Sⱼ, j being a positive integer; the training task group Sⱼ including first sample media data whose modality type is the first modality type and second sample media data whose modality type is the second modality type; a predicted modality representation vector corresponding to the training task group Sⱼ including a predicted representation feature corresponding to the first sample media data and a predicted representation feature corresponding to the second sample media data; and
an implementation in which the second optimization module 16 optimizes the cross-modality routing layer based on the predicted modality representation vector corresponding to the training task group whose modality type is the cross-modality type includes:
determining a second feature similarity between the predicted representation feature corresponding to the first sample media data and the predicted representation feature corresponding to the second sample media data;
determining each training task group whose modality type is the cross-modality type as a cross-modality training task group, and determining a third feature similarity between the training task group Sⱼ and remaining cross-modality training task groups of the at least two cross-modality training task groups; the remaining cross-modality training task groups being cross-modality training task group other than the training task group Sⱼ in the at least two cross-modality training task group; and

optimizing the cross-modality routing layer based on the second feature similarity and the third feature similarity.

In some embodiments, the data processing apparatus 1 may further include: a task group acquisition module 17, an interaction processing module 18, a feature processing module 19, and a category recognition module 20.

The task group acquisition module 17 is configured to acquire a target task group configured for describing to-be-classified media data; the target task group including at least two pieces of media data of different modality types.

The interaction processing module 18 is configured to perform attention interaction processing on the target task group in the modality representation model to obtain an attention representation vector corresponding to the target task group.

The feature processing module 19 is configured to perform, in the optimized cross-modality routing layer, feature prediction processing on the attention representation vector corresponding to the target task group to obtain a predicted modality representation vector corresponding to the target task group.

The category recognition module 20 is configured to perform category recognition processing on the predicted modality representation vector corresponding to the target task group to obtain a media category to which the to-be-classified media data belongs; the media category to which the to-be-classified media data belongs being configured for filing the to-be-classified media data.

For implementations of the task group acquisition module 17, the interaction processing module 18, the feature processing module 19, and the category recognition module 20, reference may be made to the descriptions of operation S104 in the foregoing embodiment corresponding to FIG. 2.

In some embodiments, a routing distribution mechanism may be configured in the modality representation model, and routing layers are classified into a single-modality routing layer and a cross-modality routing layer. Different routing layers may process data of different modality types, and the data of different modality types is respectively trained and optimized during training. Each routing layer may retain only related information of a current modality type, so that data of any modality type does not may be discarded, and representation vectors of the cross-modality type and the single-modality type can be simultaneously outputted, thereby well improving accuracy of representation results of data of various modality types.

Further, referring to FIG. 9, FIG. 9 is a schematic structural diagram of a computer device according to some embodiments. As shown in FIG. 9, a computer device 8000 may include: a processor 8001, a network interface 8004, and a memory 8005. In addition, the computer device 8000 may further include: a user interface 8003, and at least one communication bus 8002. The communications bus 8002 is configured to implement connection and communication between the components. The user interface 8003 may include a display, a keyboard, and in some embodiments, the user interface 8003 may further include a standard wired interface and a standard wireless interface. In some embodiments, the network interface 8004 may include a standard wired interface and a standard wireless interface (such as a wireless fidelity (Wi-Fi) interface). The memory 8005 may be a high-speed random access memory (RAM), or may be a non-volatile memory, for example, at least one magnetic disk memory. In some embodiments, the memory 8005 may be at least one storage apparatus away from the foregoing processor 8001. As shown in FIG. 9, the memory 8005 used as a computer-readable storage medium may include an operating system, a network communication module, a user interface module, and a device-control application program.

In the computer device 8000 shown in FIG. 9, the network interface 8004 may provide a network communication function. The user interface 8003 may be configured to provide an input interface for a user. The processor 8001 may be configured to invoke the device-control application program stored in the memory 8005 to implement:
acquiring a training task group set; the training task group set including a training task group Sᵢ, i being a positive integer; a modality type to which the training task group Sᵢ belongs being a single-modality type or a cross-modality type; when the modality type to which the training task group Sᵢ belongs is the single-modality type, the training task group Sᵢ including a piece of sample media data; and when the modality type to which the training task group Si belongs is the cross-modality type, the training task group Si including at least two pieces of sample media data of different modality types;
performing attention interaction processing on the training task group Sᵢ in a modality representation model to obtain an attention representation vector corresponding to the training task group Sᵢ; the attention interaction processing being configured for making different elements in the training task group Sᵢ fully interact;
determining, in a single-modality routing layer and a cross-modality routing layer that are included in the modality representation model, a target routing layer matching the modality type to which the training task group Sᵢ belongs, and performing feature prediction processing on the attention representation vector corresponding to the training task group Sᵢ based on the target routing layer to obtain a predicted modality representation vector corresponding to the training task group Sᵢ; and
optimizing, when a predicted modality representation vector corresponding to each training task group in the training task group set is determined, the single-modality routing layer based on the predicted modality representation vector corresponding to the training task group whose modality type is the single-modality type, and optimizing the cross-modality routing layer based on the predicted modality representation vector corresponding to the training task group whose modality type is the cross-modality type; an optimized single-modality routing layer being configured to perform feature prediction processing on a task group whose modality type is the single-modality type, and an optimized cross-modality routing layer being configured to perform feature prediction processing on a task group whose modality type is the cross-modality type.

The computer device 8000 described in some embodiments can implement the descriptions about the data processing method in the foregoing embodiment corresponding to FIG. 2, and can also implement the descriptions about the data processing apparatus 1 in the foregoing embodiment corresponding to FIG. 8. Details are not described herein again. In addition, the descriptions of beneficial effects of the same method are not described herein again.

In addition, some embodiments further provide a computer-readable storage medium. The computer-readable storage medium stores a computer program executed by the computer device 8000 for data processing, and the computer program includes program instructions. When executing the program instructions, the processor can perform the descriptions of the data processing method in the foregoing embodiment corresponding to FIG. 2. In addition, the descriptions of beneficial effects of the same method are not described herein again. For technical details that are not disclosed in some embodiments of the computer-readable storage medium as referred to in the disclosure, reference may be made to the descriptions about the method embodiments of the disclosure.

The foregoing computer-readable storage medium may be a data processing apparatus provided in any of the foregoing embodiments or an internal storage unit of the foregoing computer device, such as a hard disk or an internal memory of the computer device. The computer-readable storage medium may be an external storage device of the computer device, such as a plug-in hard disk, a smart media card (SMC), a secure digital (SD) card, or a flash card equipped on the computer device. Further, the computer-readable storage medium may further include both the internal storage unit and the external storage device of the computer device. The computer-readable storage medium is configured to store the computer program and other programs and data that are obtained by the computer device. The computer-readable storage medium may be further configured to temporarily store data that has been outputted or is to be outputted.

According to an aspect, the disclosure provides a computer program product, the computer program product including a computer program, and the computer program being stored in a computer-readable storage medium. A processor of a computer device reads the computer program from the computer-readable storage medium, and the processor executes the computer program, causing the computer device to perform the method in one aspect of some embodiments.

The terms “first”, “second”, and the like in the specification of some embodiments, the claims, and the accompanying drawings are intended to distinguish different objects, instead of describing a sequence. In addition, the term “include/comprise” and any variations thereof are intended to cover a non-exclusive inclusion. For example, processes, methods, apparatuses, products, or devices including a series of operations or units are not limited to the listed operations or modules, but instead, include operations or modules not listed in some embodiments, or include other operations or units inherent to these processes, methods, apparatuses, products, or devices in some embodiments.

A person of ordinary skill in the art may realize that, units and algorithm operations of each example described in combination with the disclosed embodiments herein can be implemented by electronic hardware, computer software, or a combination thereof. To clearly describe the interchangeability between the hardware and the software, compositions and operations of each example have been generally described based on functions in the foregoing descriptions. Whether the functions are executed in a mode of hardware or software depends on applications and design constraint conditions of the technical solutions. A person skilled in the art may use different methods to implement the described functions for each application, but such implementation is not to be considered beyond the scope of the disclosure.

The methods and related apparatuses provided in some embodiments are described with reference to the method flowcharts and/or schematic structural diagrams provided in some embodiments. Each flow and/or block in the method flowcharts and/or the schematic structural diagrams and a combination of flows and/or blocks in the flowcharts and/or the block diagrams may be implemented according to computer program instructions. These computer program instructions may be provided to a general-purpose computer, a special-purpose computer, an embedded processor, or a processor of another programmable data processing device to generate a machine, so that the instructions executed by the computer or the processor of the another programmable data processing device generate an apparatus for implementing a specified function in one or more processes in the flowcharts and/or in one or more blocks in the schematic structural diagrams. The computer program instructions may be stored in a computer-readable memory that can guide a computer or another programmable data processing device to operate in a manner, so that the instructions stored in the computer-readable memory generate an artifact including an instruction apparatus. The instruction apparatus implements the functions specified in one or more processes of the flowcharts and/or one or more blocks of the schematic diagrams of the structures. The computer program instructions may be loaded onto a computer or another programmable data processing device, so that a series of operations are performed on the computer or the another programmable device to generate computer-implemented processing. Therefore, the instructions executed on the computer or the another programmable device provide operations for implementing the functions specified in one or more processes of the flowcharts and/or one or more blocks of the schematic diagrams of the structures.

The above descriptions are merely exemplary embodiments of the disclosure, and certainly are not intended to limit the scope of the claims of the disclosure. Therefore, equivalent variations made in accordance with the claims of the disclosure shall fall within the scope of the disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a computer device, the method comprising:
acquiring a training task group set comprising a plurality of training task groups, each denoted as Sᵢ, i being a positive integer;
determining, for each training task group Sᵢ, a modality type as a single-modality type or a cross-modality type;
wherein a training task group of the single-modality type comprises a single piece of sample media data, and a training task group of the cross-modality type comprises at least two pieces of sample media data of different modality types;
performing attention interaction on the training task group Si based on a modality representation model to obtain an attention representation vector, wherein the attention interaction is configured to allow elements in the training task group Sᵢ to interact;
determining, based on the modality type, a target routing layer from a single-modality routing layer and a cross-modality routing layer in the modality representation model;
performing feature prediction on the attention representation vector based on the target routing layer to obtain a predicted modality representation vector;
optimizing the single-modality routing layer based on the predicted modality representation vector and the modality type being the single-modality type; and
optimizing the cross-modality routing layer based on the predicted modality representation vector and the modality type being the cross-modality type;
wherein the optimized single-modality routing layer is configured to perform feature prediction on a task group of the single-modality type, and an optimized cross-modality routing layer is configured to perform feature prediction on a task group of the cross-modality type.

2. The method according to claim 1, wherein the acquiring comprises:
acquiring N pieces of sample media data; N being a positive integer, wherein each of the N pieces of sample media data belongs to a first modality type or a second modality type that is different from the first modality type; and
performing task group construction on the N pieces of sample media data based on the modality type of the N pieces of sample media data to obtain the training task group set.

3. The method according to claim 2, wherein the performing task group construction comprises:
combining first sample media data from the N pieces of sample media data of the first modality type with a first identifier representing the first modality type to obtain a first training task group of the first modality type;
combining second sample media data from the N pieces of sample media data of the second modality type with a second identifier representing the second modality type to obtain a second training task group of the second modality type; performing cross-modality combination on the first sample media data and the second sample media data based on media source channels corresponding to the first sample media data and the second sample media data to obtain a training task group of the cross-modality type;
including the first training task group and the second training task group as training task groups of the single-modality type;
including the cross-modality training task group to form the training task group set;
determining the first training task group and the second training task group as training task groups of the single-modality type; and
determining training task groups of the cross-modality type and the single-modality type as the training task group set.

4. The method according to claim 3,
wherein the first training task group and the second training task group each comprise one or more pieces of sample media data,
wherein the training task group of the cross-modality type comprises a training task group corresponding to a first sample media data Mⱼ, j being a positive integer;
wherein the performing cross-modality combination comprises:
determining a media source channel corresponding to the first sample media data Mⱼ as a target media source channel;
determining second sample media data whose media source channel is the target media source channel as associated sample media data corresponding to the first sample media data Mⱼ; and
combining the first sample media data Mⱼ, the associated sample media data, the first identifier, and the second identifier to obtain the training task group corresponding to the first sample media data Mⱼ.

5. The method according to claim 1, wherein the performing attention interaction comprises:
performing feature extraction on the sample media data in the training task group Si based on a feature extraction network layer of the modality representation model to obtain a media feature; and
performing multi-head self-attention on the media feature based on a multi-head self-attention network layer of the modality representation model to obtain the attention representation vector.

6. The method according to claim 5,
wherein the multi-head self-attention network layer comprises Q self-attention sub-network layers, the Q self-attention sub-network layers comprises a self-attention sub-network layer Vₖ, and Q and k are positive integers, and
wherein the performing multi-head self-attention comprises:
acquiring an attention parameter matrix from the self-attention sub-network layer Vₖ;
performing operation on the attention parameter matrix and the media feature to obtain a linear transformation matrix;
performing feature integration on the linear transformation matrix based on a connected component in the self-attention sub-network layer Vk to obtain an attention representation sub-vector; and
fusing attention representation sub-vectors from the Q self-attention sub-network layers to obtain the attention representation vector.

7. The method according to claim 1,
wherein the single-modality type comprises a first modality type and a second modality type,
wherein the single-modality routing layer comprises a first modality sub-routing layer corresponding to the first modality type and a second modality sub-routing layer corresponding to the second modality type,
wherein the determining a target routing layer comprises:
determining the cross-modality routing layer as the target routing layer based on the modality type of the training task group Si being the cross-modality type;
determining the first modality sub-routing layer as the target routing layer based on the modality type of the training task group Sᵢ being the first modality type; and
determining the second modality sub-routing layer as the target routing layer based on the modality type of the training task group Sᵢ being the second modality type.

8. The method according to claim 1,
wherein the single-modality type comprises a first modality type and a second modality type,
wherein the single-modality routing layer comprises a first modality sub-routing layer corresponding to the first modality type and a second modality sub-routing layer corresponding to the second modality type,
wherein the optimizing the single-modality routing layer comprises:
determining a training task group of the first modality type as a first modality training task group and a training task group of the second modality type as a second modality training task group;
acquiring a true modality representation vector corresponding to the first modality training task group and a true modality representation vector corresponding to the second modality training task group;
performing error calculation on a predicted modality representation vector and the true modality representation vector corresponding to the first modality training task group to obtain a first loss value;
performing error calculation on a predicted modality representation vector and the true modality representation vector corresponding to the second modality training task group to obtain a second loss value; and
optimizing the first modality sub-routing layer based on the first loss value and the second modality sub-routing layer based on the second loss value.

9. The method according to claim 8,
wherein the first modality type is a text modality type,
wherein the first modality training task group comprises a text word sequence,
wherein the predicted modality representation vector corresponding to the first modality training task group comprises predicted representation features based on text words in the text word sequence,
wherein the true modality representation vector corresponding to the first modality training task group comprises true representation features based on the text words in the text word sequence,
wherein the performing error calculation comprises:
acquiring a masked text word from the text words in the text word sequence, wherein the masked text word has been masked;
acquiring a predicted representation feature corresponding to the masked text word from the predicted modality representation vector corresponding to the first modality training task group;
acquiring a true representation feature corresponding to the masked text word from the true modality representation vector corresponding to the first modality training task group;
determining a first feature similarity between the predicted representation feature corresponding to the masked text word and the true representation feature corresponding to the masked text word; and
determining the first feature similarity as the first loss value.

10. The method according to claim 1,
wherein the training task group set comprises at least two training task groups whose modality types are the cross-modality type,
wherein a training task group Sj among the cross-modality training task groups, j being a positive integer, comprises third sample media data of the first modality type and fourth sample media data of the second modality type,
wherein a predicted modality representation vector corresponding to the training task group Sⱼ comprises a predicted representation feature corresponding to the third sample media data and a predicted representation feature corresponding to the fourth sample media data; and
wherein the optimizing the cross-modality routing layer comprises:
determining a second feature similarity between the predicted representation feature corresponding to the third sample media data and the predicted representation feature corresponding to the fourth sample media data;
determining each training task group whose modality type is the cross-modality type as a cross-modality training task group;
determining a third feature similarity between the training task group Sⱼ and remaining cross-modality training task groups of the at least two cross-modality training task groups; and
optimizing the cross-modality routing layer based on the second feature similarity and the third feature similarity.

11. The method according to claim 1, further comprising:
acquiring a target task group describing to-be-classified media data, the target task group comprising at least two pieces of media data of different modality types;
performing attention interaction on the target task group in the modality representation model to obtain an attention representation vector corresponding to the target task group;
performing, based on the optimized cross-modality routing layer, feature prediction on the attention representation vector corresponding to the target task group to obtain a predicted modality representation vector corresponding to the target task group; and
performing category recognition on the predicted modality representation vector corresponding to the target task group to determine a media category corresponding to the to-be-classified media data for filing the to-be-classified media data.

12. A data processing apparatus, comprising:
at least one memory configured to store program code; and
at least one processor configured to read the program code and operate as instructed by the program code, the program code comprising:
acquiring code configured to cause at least one of the at least one processor to acquire a training task group set comprising a plurality of training task groups, each denoted as Si, i being a positive integer;
determining code configured to cause at least one of the at least one processor to determine, for each training task group Si, a modality type as a single-modality type or a cross-modality type;
wherein a training task group of the single-modality type comprises a single piece of sample media data, and a training task group of the cross-modality type comprises at least two pieces of sample media data of different modality types;
attention code configured to cause at least one of the at least one processor to perform attention interaction on the training task group Si based on a modality representation model to obtain an attention representation vector, wherein the attention interaction is configured to allow elements in the training task group Si to interact;
routing code configured to cause at least one of the at least one processor to determine, based on the modality type, a target routing layer from a single-modality routing layer and a cross-modality routing layer in the modality representation model;
prediction code configured to cause at least one of the at least one processor to perform feature prediction on the attention representation vector based on the target routing layer to obtain a predicted modality representation vector; and
optimization code configured to cause at least one of the at least one processor to:
optimize the single-modality routing layer based on the predicted modality representation vector and the modality type being the single-modality type; and
optimize the cross-modality routing layer based on the predicted modality representation vector and the modality type being the cross-modality type;
wherein the optimized single-modality routing layer is configured to perform feature prediction on a task group of the single-modality type, and an optimized cross-modality routing layer is configured to perform feature prediction on a task group of the cross-modality type.

13. The apparatus according to claim 12, wherein the acquiring code is further configured to cause at least one of the at least one processor to:
acquire N pieces of sample media data; N being a positive integer, wherein each of the N pieces of sample media data belongs to a first modality type or a second modality type that is different from the first modality type; and
perform task group construction on the N pieces of sample media data based on the modality type of the N pieces of sample media data to obtain the training task group set.

14. The apparatus according to claim 13, wherein the acquiring code is further configured to cause at least one of the at least one processor to:
combine first sample media data from the N pieces of sample media data of the first modality type with a first identifier representing the first modality type to obtain a first training task group of the first modality type;
combine second sample media data from the N pieces of sample media data of the second modality type with a second identifier representing the second modality type to obtain a second training task group of the second modality type;
perform cross-modality combination on the first sample media data and the second sample media data based on media source channels corresponding to the first sample media data and the second sample media data to obtain a training task group of the cross-modality type;
include the first training task group and the second training task group as training task groups of the single-modality type; and
include the cross-modality training task group to form the training task group set.

15. The apparatus according to claim 14,
wherein the first training task group and the second training task group each comprise one or more pieces of sample media data,
wherein the training task group of the cross-modality type comprises a training task group corresponding to a first sample media data Mj, j being a positive integer;
wherein the acquiring code is further configured to cause at least one of the at least one processor to:
determine a media source channel corresponding to the first sample media data Mj as a target media source channel;
determine second sample media data whose media source channel is the target media source channel as associated sample media data corresponding to the first sample media data Mj; and
combine the first sample media data Mj, the associated sample media data, the first identifier, and the second identifier to obtain the training task group corresponding to the first sample media data Mj.

16. The apparatus according to claim 12, wherein the attention code is further configured to cause at least one of the at least one processor to:
perform feature extraction on the sample media data in the training task group Si based on a feature extraction network layer of the modality representation model to obtain a media feature; and
perform multi-head self-attention on the media feature based on a multi-head self-attention network layer of the modality representation model to obtain the attention representation vector.

17. The apparatus according to claim 16,
wherein the multi-head self-attention network layer comprises Q self-attention sub-network layers, the Q self-attention sub-network layers comprise a self-attention sub-network layer Vk, and Q and k are positive integers; and
wherein the attention code is further configured to cause at least one of the at least one processor to:
acquire an attention parameter matrix from the self-attention sub-network layer Vk;
perform operation on the attention parameter matrix and the media feature to obtain a linear transformation matrix;
perform feature integration on the linear transformation matrix based on a connected component in the self-attention sub-network layer Vk to obtain an attention representation sub-vector; and
fuse attention representation sub-vectors from the Q self-attention sub-network layers to obtain the attention representation vector.

18. The apparatus according to claim 12,
wherein the single-modality type comprises a first modality type and a second modality type,
wherein the single-modality routing layer comprises a first modality sub-routing layer corresponding to the first modality type and a second modality sub-routing layer corresponding to the second modality type,
wherein the routing code is further configured to cause at least one of the at least one processor to:
determine the cross-modality routing layer as the target routing layer based on the modality type of the training task group Si being the cross-modality type;
determine the first modality sub-routing layer as the target routing layer based on the modality type of the training task group Si being the first modality type; and
determine the second modality sub-routing layer as the target routing layer based on the modality type of the training task group Si being the second modality type.

19. The apparatus according to claim 12,
wherein the single-modality type comprises a first modality type and a second modality type,
wherein the single-modality routing layer comprises a first modality sub-routing layer corresponding to the first modality type and a second modality sub-routing layer corresponding to the second modality type,
wherein the optimization code is further configured to cause at least one of the at least one processor to:
determine a training task group of the first modality type as a first modality training task group and a training task group of the second modality type as a second modality training task group;
acquire a true modality representation vector corresponding to the first modality training task group and a true modality representation vector corresponding to the second modality training task group;
perform error calculation on a predicted modality representation vector and the true modality representation vector corresponding to the first modality training task group to obtain a first loss value;
perform error calculation on a predicted modality representation vector and the true modality representation vector corresponding to the second modality training task group to obtain a second loss value; and
optimize the first modality sub-routing layer based on the first loss value and the second modality sub-routing layer based on the second loss value.

20. A non-transitory computer-readable storage medium, storing computer code which, when executed by at least one processor, causes the at least one processor to at least:
acquire a training task group set comprising a plurality of training task groups, each denoted as Si, i being a positive integer;
determine, for each training task group Si, a modality type as a single-modality type or a cross-modality type;
wherein a training task group of the single-modality type comprises a single piece of sample media data, and a training task group of the cross-modality type comprises at least two pieces of sample media data of different modality types;
perform attention interaction on the training task group Si based on a modality representation model to obtain an attention representation vector, wherein the attention interaction is configured to allow elements in the training task group Si to interact;
determine, based on the modality type, a target routing layer from a single-modality routing layer and a cross-modality routing layer in the modality representation model;
perform feature prediction on the attention representation vector based on the target routing layer to obtain a predicted modality representation vector; and
optimize the single-modality routing layer based on the predicted modality representation vector and the modality type being the single-modality type; and
optimize the cross-modality routing layer based on the predicted modality representation vector and the modality type being the cross-modality type;
wherein the optimized single-modality routing layer is configured to perform feature prediction on a task group of the single-modality type, and an optimized cross-modality routing layer is configured to perform feature prediction on a task group of the cross-modality type.
